(19) United States
(12) Patent Application Publication
(10) Pub. No.: US 2003/0177366 A1
(43) Pub. Date: Sep. 18, 2003

(54) Method and apparatus for dynamic personal identification number management

(75) Inventor: Eduard de Jong, San Mateo, CA (US)

Correspondence Address: David B. Ritchie, Thelen Reid & Priest LLP, P.O. Box 640640, San Jose, CA, 95164-0640, US

(73) Assignee: Sun Microsystem, Inc., a Delaware Corporation

(21) Appl. No.: 10/101,303

(22) Filed: Mar. 18, 2002

(51) Int. Cl. H04K 1/00

(52) U.S. Cl. 713/184

(57) ABSTRACT

A method for dynamic personal identification number (PIN) management includes selecting a PIN comprising at least one picture category ID, determining a correspondence between at least one entry token and the at least one picture category ID and creating a picture category ID list in response to an access request. The picture category ID list includes the at least one picture category ID. The method also includes providing the picture category ID list for displaying a composite image including pictures based on the picture category ID list, receiving an entry token list in response to the providing and granting access to the service based upon whether at least one entry token in the entry token list corresponds to the at least one picture category ID. According to one aspect, the method also includes providing instructions to the user regarding which pictures are based on the PIN.

### FIELD OF THE INVENTION

The present invention relates to the field of computer science. More particularly, the present invention relates to a method and apparatus for dynamic personal identification number management.

### BACKGROUND OF THE INVENTION

The challenge of identifying or authenticating a person on a local computer, or on the other end of a communication session, or in the role of the sender of a message, is a recurring theme in e-business. A typical solution uses user authentication methods based on passwords or PINs (personal identification numbers). A password or PIN is a word or code used as a security measure against unauthorized access to data. Typically, a user obtains a PIN as part of an enrollment process with a service provider. In this enrollment process, the service provider assesses user-supplied information and decides whether to provide the service to the user. If the service provider decides to provide service, the service provider issues a PIN to the user.

After enrolling with the service provider, the user uses the PIN to obtain access to the service. The user interface in this case consists of a prompt for a PIN. The user is typically allowed a fixed number of unsuccessful PIN attempts before user access is blocked.

A PIN or password is typically the primary means by which an individual user indicates authorization based on an intelligent thought process performed by the user. The user must recall the PIN from the user's memory and enter the digits corresponding to the PIN to obtain access to a service. PINs are often difficult to remember, especially when a user uses more than one PIN to access different services. A user may create a written copy of the PIN or PINs in an attempt to remember them. However, such a practice degrades security because the paper containing the PIN or PINs can be stolen or forwarded freely. Thus, static PIN-based user authentication mechanisms provide a relatively low level of security.

An improved form of user authentication is made possible by using a smart card or a magnetic stripe card in conjunction with a PIN. This is sometimes referred to as “two-factor” user authentication, combining “what you have” (the physical card) with “what you know” (the password needed to use the card). Because both possession of the card and knowledge of the PIN are required, two-factor user authentication can provide a higher level of security than user authentication based on a PIN or on a card alone.

Unlike a magnetic strip card, a smart card may include a CPU (central processing unit). Such a smart card can process data such as a PIN locally on the card. This processing may include PIN verification. Once a user is authenticated to the card, the card can be used to obtain access to a service.

FIG. 1 is a block diagram that illustrates a typical mechanism for personal identification number (PIN) management. A service provider 145 maintains a centralized cardholder database 105 that includes a primary account number (PAN) and an associated PIN for each cardholder. A cryptographic algorithm is typically used to generate the PIN based upon a cryptographic key 125, the PAN 110 and possibly other data 130. The PAN for a user 135 is written on a magnetic strip card or smart card 100 and the card 100 is provided to the user 135. If the card 100 is a smart card, it may include additional unique identifying information, such as a card serial number. The user 135 gains access to the account associated with a card 100 by presenting the card 100 to a card reader or card acceptance device (CAD) 140 in communication with the centralized cardholder database 105 and by entering a PIN. The CAD 140 may be implemented in a PC or as a standalone device. The centralized cardholder database 105 grants user 135 access to the account if the PAN on the card 100 matches a PAN 110 in the database 105 and if the PIN entered by the user 135 matches the PIN that is associated with the PAN 110 in the database 105.

Unfortunately, maintaining a PIN in a centralized database 105 that is beyond user control makes PINs vulnerable to misuse by a service provider 145. It also makes the PIN vulnerable to attack by rogue software running on the service provider's system 145.

Additionally, static PINs are susceptible to attack by rogue software on a CAD 140. Such a program can create a database of card numbers or PANs and associated PINs previously entered using a particular CAD 140. If a CAD 140 obtains any unique identifying data such as a serial number from the card 100 prior to PIN entry, the unique information may be used to consult the database of previously entered information to obtain an associated PIN. This PIN may be used to obtain unauthorized access to a service before the user 135 has authorized use of the card 100.

A rogue software program running on a CAD 140 may also reuse a PIN after the PIN has been entered and recognized by the card 100 to obtain further services without user 135 intervention. This CAD-based vulnerability decreases the security afforded by typical “two-factor” approaches.

An improvement is made possible by using a certified CAD 140 having a PIN-pad mounted directly on the CAD 140. Such a CAD 140 protects against rogue software running on the CAD 140. However, producing certified CADs and maintaining their operational state is relatively expensive and time-consuming.

Accordingly, what is needed is a relatively secure user authentication solution having a relatively simple user interface. A further need exists for such a solution that provides relatively limited access to an individual's PIN. Yet another need exists for such a solution where the user authentication data required for subsequent user authentication attempts is dynamic. Yet another need exists for such a solution that is relatively inexpensive.

### SUMMARY OF THE INVENTION

A method for dynamic personal identification number (PIN) management includes selecting a PIN comprising at least one picture category ID, determining a correspondence between at least one entry token and the at least one picture category ID and creating a picture category ID list in response to an access request. The picture category ID list includes the at least one picture category ID. The method also includes providing the picture category ID list for displaying a composite image including pictures based on the picture category ID list, receiving an entry token list in response to the providing and granting access to the service based upon whether at least one entry token in the entry token list corresponds to the at least one picture category ID. According to one aspect, the method also includes providing instructions to the user regarding which pictures are based on the PIN.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram that illustrates a typical mechanism for personal identification number (PIN) management.

FIG. 2 is a block diagram of a computer system suitable for implementing aspects of the present invention.

FIG. 3 is a block diagram that illustrates an integrated apparatus for dynamic PIN management in accordance with one embodiment of the present invention.

FIG. 4 is a block diagram that illustrates a composite image including superimposed entry tokens in accordance with one embodiment of the present invention.

FIG. 5 is a block diagram that illustrates a composite image including superimposed entry tokens in accordance with one embodiment of the present invention.

FIG. 6 is a block diagram that illustrates a composite image including superimposed entry tokens in accordance with one embodiment of the present invention.

FIG. 7 is a block diagram that illustrates a composite image including multiple sub-pictures within a picture in accordance with one embodiment of the present invention.

FIG. 8A is a block diagram that illustrates a composite image including randomized superimposed entry tokens in accordance with embodiments of the present invention.

FIG. 8B is a block diagram that illustrates a composite image without superimposed entry tokens in accordance with one embodiment of the present invention.

FIG. 8C is a block diagram that illustrates a composite image including noncontiguous superimposed entry tokens in accordance with one embodiment of the present invention.

FIG. 8D is a block diagram that illustrates a composite image including superimposed entry tokens on a subset of pictures in accordance with one embodiment of the present invention.

FIG. 9 is a block diagram that illustrates a composite image having pictures that are displayed serially in one-member groups in accordance with one embodiment of the present invention.

FIG. 10 is a block diagram that illustrates a composite image having pictures that are displayed serially in two-member groups in accordance with one embodiment of the present invention.

FIG. 11 is a block diagram that illustrates a composite image having pictures that are displayed serially in four-member groups in accordance with one embodiment of the present invention.

FIG. 12 is a block diagram that illustrates an integrated apparatus for dynamic PIN management that includes providing a user with PIN instructions in accordance with one embodiment of the present invention.

FIG. 13 is a block diagram that illustrates a distributed apparatus for dynamic PIN management in accordance with one embodiment of the present invention.

FIG. 14 is a block diagram that illustrates a distributed apparatus for dynamic PIN management using a smart card in accordance with one embodiment of the present invention.

FIG. 15 is a block diagram that illustrates a distributed apparatus for dynamic PIN management using a smart card to select four of nine picture categories in accordance with one embodiment of the present invention.

FIG. 16 is a block diagram that illustrates a distributed apparatus for dynamic PIN management using a smart card in and a separate composite image server accordance with one embodiment of the present invention.

FIG. 17 is a flow diagram that illustrates a method for dynamic PIN management in accordance with one embodiment of the present invention.

FIG. 18 is a flow diagram that illustrates a method for dynamic PIN management in accordance with one embodiment of the present invention.

FIG. 19 is a flow diagram that illustrates a method for dynamic PIN management in accordance with one embodiment of the present invention.

FIG. 20 is a flow diagram that illustrates a method for dynamic PIN management that includes providing a user with PIN instructions in accordance with one embodiment of the present invention.

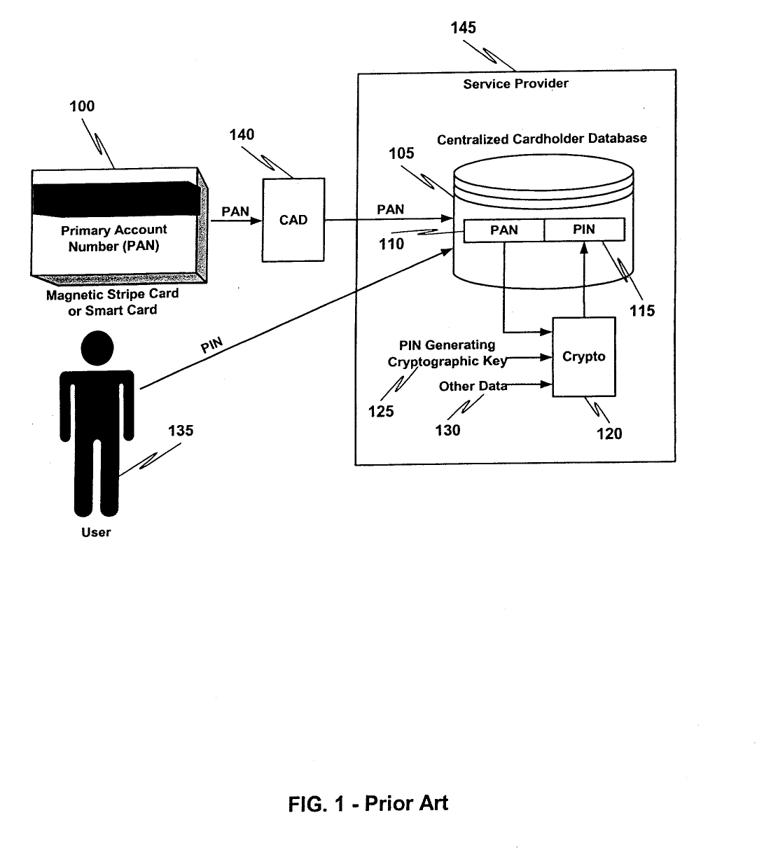

### DETAILED DESCRIPTION

Embodiments of the present invention are described herein in the context of a method and apparatus for dynamic personal identification number management. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order, to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In the context of the present invention, the term “network” includes local area networks, wide area networks, the Internet, cable television systems, telephone systems, wireless telecommunications systems, fiber optic networks, ATM networks, frame relay networks, satellite communications systems, and the like. Such networks are well known in the art and consequently are not further described here.

In the context of the present invention, the term “randomized” describes the result of a random or pseudo-random number generation process. A “randomized process” describes the application of such a result to a process. Methods of generating random and pseudo-random numbers are known by those skilled in the relevant art.

In accordance with one embodiment of the present invention, the components, processes and/or data structures may be implemented using C or C++ programs running on high performance computers (such as an Enterprise 2000™ server running Sun Solaris™ as its operating system. The Enterprise 2000™ server and Sun Solaris™ operating system are products available from Sun Microsystems, Inc. of Palo Alto, Calif.). Different implementations may be used and may include other types of operating systems, computing platforms, computer programs, firmware, computer languages and/or general-purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

According to embodiments of the present invention, access to a service is controlled based upon user-selection of one or more pictures.

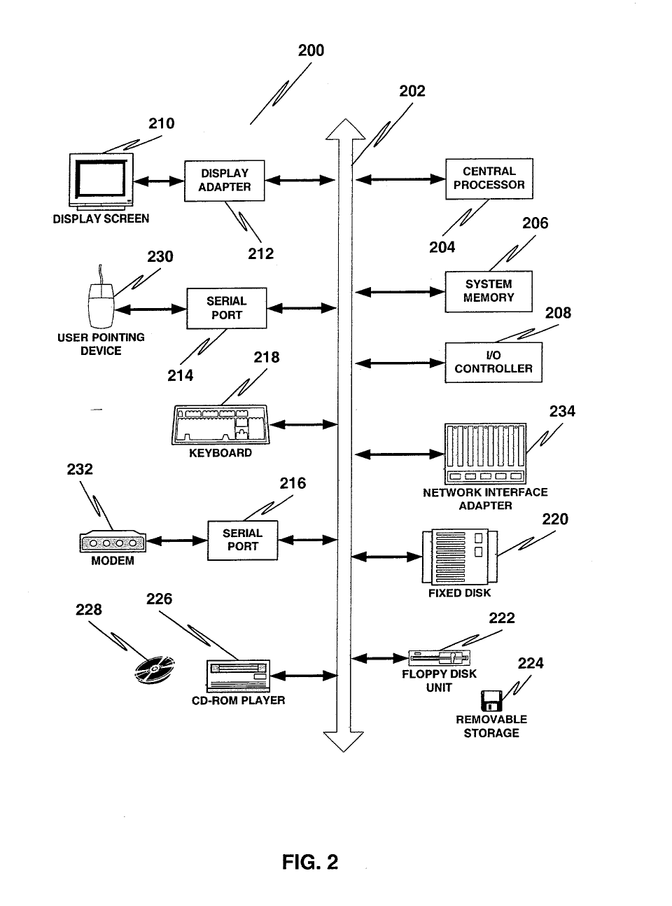

FIG. 2 depicts a block diagram of a computer system 200 suitable for implementing aspects of the present invention. As shown in FIG. 2, computer system 200 includes a bus 202 which interconnects major subsystems such as a central processor 204, a system memory 206 (typically RAM), an input/output (I/O) controller 208, an external device such as a display screen 210 via display adapter 212, serial ports 214 and 216, a keyboard 218, a fixed disk drive 220, a floppy disk drive 222 operative to receive a floppy disk 224, and a CD-ROM player 226 operative to receive a CD-ROM 228. Many other devices can be connected, such as a pointing device 230 (e.g., a mouse) connected via serial port 214 and a modem 232 connected via serial port 216. Modem 232 may provide a direct connection to a remote server via a telephone link or to the Internet via a POP (point of presence). Alternatively, a network interface adapter 234 may be used to interface to a local or wide area network using any network interface system known to those skilled in the art (e.g., Ethernet, xDSL, AppleTalk™).

Many other devices or subsystems (not shown) may be connected in a similar manner. Also, it is not necessary for all of the devices shown in FIG. 2 to be present to practice the present invention, as discussed below. Furthermore, the devices and subsystems may be interconnected in different ways from that shown in FIG. 2. The operation of a computer system such as that shown in FIG. 2 is readily known in the art and is not discussed in detail in this application, so as not to overcomplicate the present discussion. Code to implement the present invention may be operably disposed in system memory 206 or stored on storage media such as fixed disk 220, floppy disk 224 or CD-ROM 228.

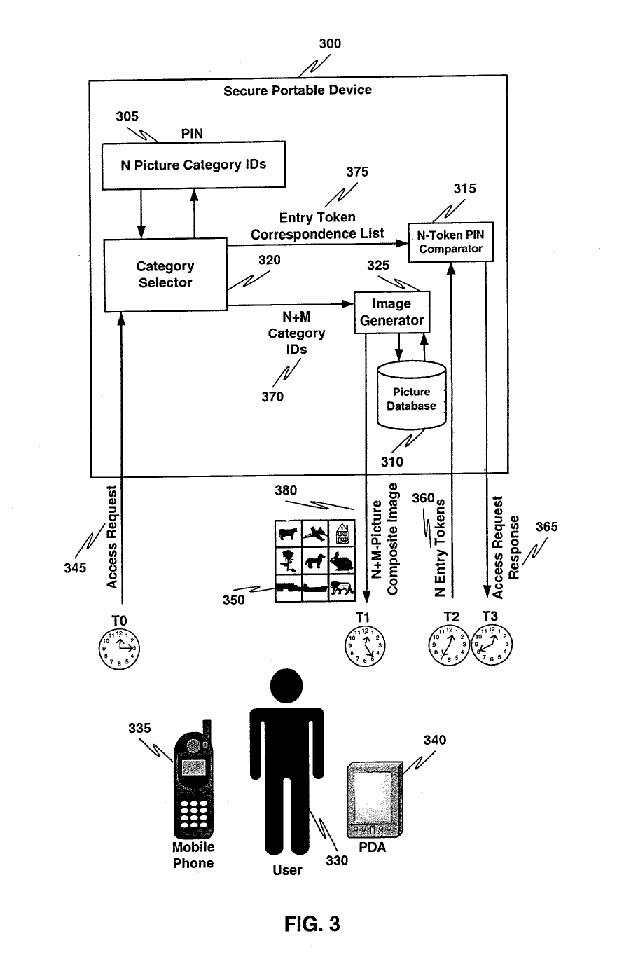

Turning now to FIG. 3, a block diagram that illustrates an integrated apparatus for dynamic PIN management in accordance with one embodiment of the present invention is presented. Secure portable device 300 may be any trusted portable device such as a mobile phone or a Java Card™ technology-enabled smart card, or the like. Java Card™ technology is described in Z. Chen, Java Card™ Technology for Smart Cards (2000). Secure portable device 300 includes a stored PIN 305 that comprises at least one picture category ID and a category selector 320 for creating a picture category ID list 370 and an entry token correspondence list 375. The picture category ID list 370 includes a first number (N) of picture category IDs that comprise the stored PIN 305, referred to herein as “PIN picture category IDs”. The picture category ID list 370 also includes a second number (M) of additional category IDs, referred to herein as “filler category IDs”. Entry token correspondence list 375 includes at least one entry token that corresponds with the at least one picture category ID. Secure portable device 300 also includes a PIN comparator 315 for comparing an entry token list 360 with the entry token correspondence list 375. Device 300 also includes a picture database 310 for storing categorized pictures and an image generator 325 for generating a composite image 355 that includes pictures corresponding to the picture categories in the picture category ID list 370.

In operation, a user 330 requests access to a service (345). The requested service includes anything for which restricted access is desired. By way of example, a requested service may provide access to a range of Internet services via an Internet portal. Category selector 320 receives the access request 345 and creates an entry token correspondence list 375 that includes at least one entry token that corresponds with the at least one picture category ID in the PIN 305. Category selector 320 also creates a picture category ID list 370 including picture category IDs comprising the PIN. According to one embodiment of the present invention, the ordering of the picture category IDs within the picture category ID list 370 determines the order the corresponding pictures will be presented to the user 330. The PIN picture category IDs may be interspersed with the filler category IDs within the picture category ID list. Category selector 320 presents the picture category ID list 370 to image generator 325. For each picture category ID in the picture category ID list 370, the image generator 325 selects a picture that belongs to the picture category from the picture database 310. A picture that belongs to a PIN picture category is called a “PIN picture”. A picture that belongs to a filler category is called a “Filler picture”. Image generator 325 then combines the selected pictures into a composite image 350.

According to one embodiment of the present invention, secure portable device 300 comprises a CDMA technology-enabled smart card. CDMA technology-enabled smart cards are described in CDMA Development Group Document #43, entitled “Smart Card Stage I Description”, Version 1.1, May 22, 1996, available at www.cdg.org.

According to another embodiment of the present invention, secure portable device 300 comprises a SIM (Subscriber Identity Module card) card. The term “SIM card” describes the smart card used in GSM (Global System for Mobile Communications) mobile telephones. The SIM includes the subscriber's personal cryptographic identity key and other information such as the current location of the phone and an address book of frequently called numbers. The SIM is described in “GSM 11.11-Digital cellular telecommunications system (Phase 2+); Specification of the Subscriber Identity Module-Mobile Equipment (SIM-ME) interface (GSM 11.11)”, available at www.etsi.org.

According to another embodiment of the present invention, secure portable device 300 comprises a WIM (Wireless Interface Module). A WIM is a smart card in a WAP (Wireless Application Protocol) phone. It is described in “Wireless Identity Module Specification, available at www.wapforum.org.

According to another embodiment of the present invention, secure portable device 300 comprises a USIM (Universal Subscriber Identity Module). A USIM is a smart card for a 3GPP (3^{rd} Generation Partnership Project) mobile phone. It is described in 3G TS 21.111 Version 4.0.0, USIM and IC Card Requirements, available at www.3gpp.org.

According to another embodiment of the present invention, secure portable device 300 comprises a UIM (User Identity Module). A UIM is a smart card for a 3GPP Project 2 (3GPP2) mobile phone. The term “R-UIM” is used when the smart card is removable. A UIM is a super set of the SIM and allows CDMA (Code Division Multiple Access)-based cellular subscribers to roam across geographic and device boundaries. The R-UIM is described in a specification issued by the 3rd Generation Partnership Project 2 (3GPP2) and entitled “Removable User Identity Module (R-UIM) for cdma2000 Spread Spectrum Systems (3GPP2 C.S0023-0)”, Jun. 9, 2000, available at http://3gpp2.org.

The above description regarding various mobile phone technologies is not intended to be limiting in any way. Those of ordinary skill in the art will recognize that other secure portable devices may be used.

According to one embodiment of the present invention, the positioning of pictures within the composite image is based upon the corresponding picture category ID's position in the picture category ID list 370. In one exemplary mapping, the first picture category ID in the picture category ID list 370 corresponds to the first picture in the composite image 350 and the second picture category ID in the picture category ID list 370 corresponds to the second picture in the composite image 355. The mapping for other categories in the picture category ID list proceeds in a similar fashion. Those of ordinary skill in the art will recognize that other mappings between the position of a category ID within a picture category ID list and the position within a composite image of a picture corresponding to the picture category are possible.

Still referring to FIG. 3, at 380 the composite image 350 is presented to the user 330. The composite image 350 may be presented to the user 330 via the user's mobile phone 335, Personal Digital Assistant (PDA) 340 or the like. The composite image 350 may also be displayed to the user 330 via the display device of a PC or workstation (not shown in FIG. 3). The user 330, having previously enrolled with the secure portable device 300, knows which pictures within the composite image 350 are PIN pictures. At 360 the user 330 enters one or more entry tokens corresponding to the PIN pictures within the composite image 350. PIN comparator 315 receives the entry token correspondence list 375 from category selector 320. PIN comparator 315 also receives the entry token list 360 and compares it to the entry token correspondence list 375. The lists match if the entry token list meets correspondence criteria established by the secure portable device 300. If the lists match, access to the service is granted at 365. If the lists do not match, access to the service is denied at 365.

According to one embodiment of the present invention, the correspondence criteria is such that the user 330 must enter an entry token corresponding to each PIN picture, but additional entry tokens are acceptable.

According to one embodiment of the present invention, the correspondence criteria is such that the user 330 must enter one or more entry tokens corresponding to at least one PIN picture. In other words, the correspondence criteria are such that access is granted if the value of each of the entry tokens in the entry token list 360 corresponds to a picture category in the PIN 305. In this case, an entry token list is an acceptable response if it includes entry tokens corresponding to less than all of the PIN picture categories. For example, suppose a PIN 305 comprises four PIN picture categories and the correspondence criteria indicate a response including three of the four PIN picture categories is acceptable. If the PIN picture categories are “dog”, “chair”, “house” and “flower”, a response that includes the “dog”, “house” and “flower” categories but not the “chair” category would be acceptable.

According to another embodiment of the present invention, the correspondence criteria is such that access is granted if the value of each of the entry tokens in the entry token list 360 corresponds to a picture category in the PIN 305, and if each picture category ID in the PIN 305 is represented by an entry token in the entry token list 360. In other words, the user must 330 enter an entry token corresponding to each picture category in the PIN 305, and no more.

According to another embodiment of the present invention, the correspondence criteria is such that access is granted if the value of each of the entry tokens in the entry token list 360 is entered in the order indicated by the entry token correspondence list 375.

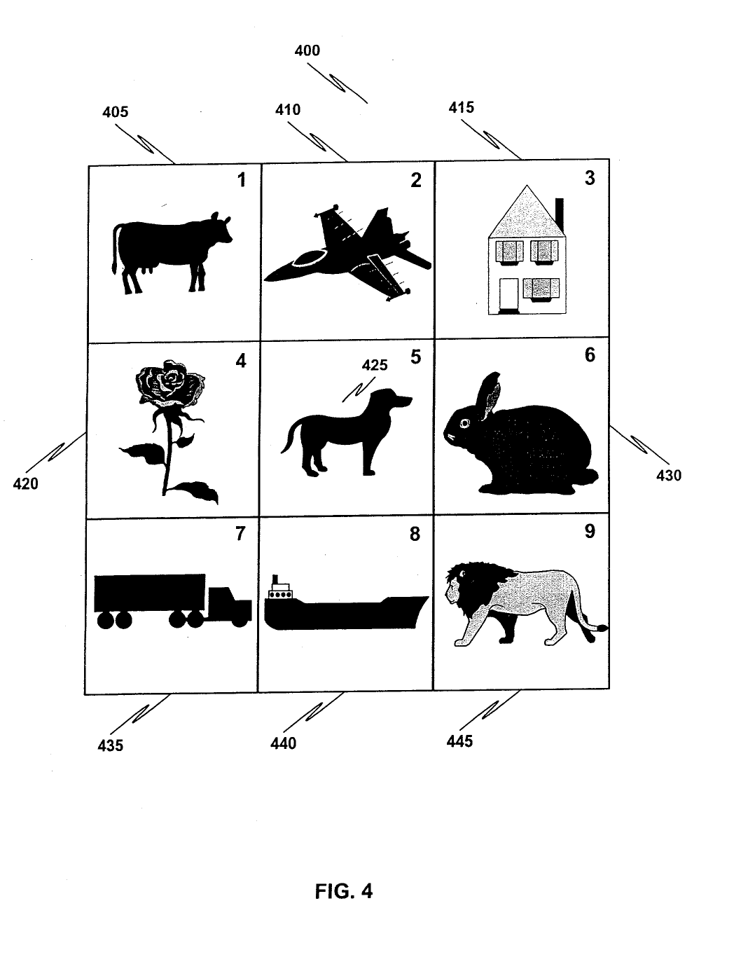

According to another embodiment of the present invention, the correspondence criteria may indicate that the order of entry tokens is irrelevant. For example, if the number of picture category IDs is 9 and the number of PIN picture category IDs is 3, the correspondence criteria may be such that matching all of the three PIN picture category IDs in any order is acceptable. Using FIG. 4 as an example, if the PIN picture categories are “cow”, “dog” and “rabbit”, the acceptable responses are entry token lists that include the three PIN pictures. In the present example, the acceptable responses are the entry token lists “1-5-6”, “1-6-5”, “5-1-6”, “5-6-1”, “6-5-1” and “6-1-5”.

Many embodiments described herein assume a required entry order for entry tokens, from lower-valued entry tokens to higher-valued entry tokens, from left to right and from top to bottom. This is not intended to be limiting in any way. Embodiments of the present invention may use a variety of entry orders and other correspondence criteria.

According to another embodiment of the present invention, the image generator (reference numeral 325 of FIG. 3) uses a randomized selection process to select a picture when more than one picture belongs to the same picture category. For example, if one of the picture categories received by the image generator 325 is the “cow” category and the picture database 310 includes ten cow pictures, image generator 325 uses a randomized process to select one of the ten cow pictures for inclusion in the composite image 350.

According to another embodiment of the present invention, the image generator 325 selects a particular picture based in part upon the last time the picture was selected. By way of example, if more than one picture belongs to the same picture category, the least-recently-selected picture may be selected.

According to embodiments of the present invention, a secure portable device 300 uses a randomized selection process to create the picture category ID list 370. The PIN picture category IDs must appear in each picture category ID list 370, but a randomized process may be used to determine the order of each PIN picture category ID within the picture category ID list 370. A randomized process may be used to determine the identity of filler category IDs within the picture category ID list 370, the order of filler category IDs in the picture category ID list 370, or both. Dynamically changing the picture category ID list 370 means that the user 330 will be presented with a different composite image 350 with each successive access request 345. If the order of a PIN picture category ID within the picture category ID list 370 is changed, the resulting composite image 350 will change, requiring the user 330 to enter a different sequence of entry tokens 360 to access the same service. Thus, monitoring communications between the secure portable device and the user 330 would reveal little useful information because of the difficulty in establishing any correlation between an image presented to a user 330 and a sequence of entry tokens 360 entered by the user 330 in response to the composite image 350.

Turning now to FIG. 4, a block diagram that illustrates a composite image including superimposed entry tokens in accordance with one embodiment of the present invention is presented. As shown, composite image 400 includes a square grid of nine numbered pictures: a picture of a cow 405 associated with the “cow” category, a picture of a plane 410 associated with the “plane” category, a picture of a house 415 associated with the “house” category, a picture of a flower 420 associated with the “flower” category, a picture of a dog 425 associated with the “dog” category, a picture of a rabbit 430 associated with the “rabbit” category, a picture of a truck 435 associated with the “truck” category, a picture of a ship 440 associated with the “ship” category and a picture of a lion 445 associated with the “lion” category. The ordering of the pictures (405-445) is based upon the picture category ID list generated by the secure portable device. The pictures shown and the associated picture categories are for illustrative purposes only. Those of ordinary skill in the art will recognize that many other picture categories are possible. Furthermore, those of ordinary skill in the art will recognize that many pictures may belong to the same picture category.

According to one embodiment of the present invention, the entry tokens comprise any character that can be entered using a user-input device such as a keyboard, touch-pad or the like. According to one embodiment of the present invention, the entry tokens comprise numbers. According to another embodiment of the present invention, the entry tokens comprise letters. According to another embodiment of the present invention, the entry tokens comprise non-alphanumeric symbols such as the “*”, “$” and “#” characters and the like. According to another embodiment of the present invention, the entry tokens comprise a combination of numbers, letters and non-alphanumeric symbols.

According to another embodiment of the present invention, a predetermined sequence of entry tokens is superimposed on pictures in the composite image. Several examples are presented below.

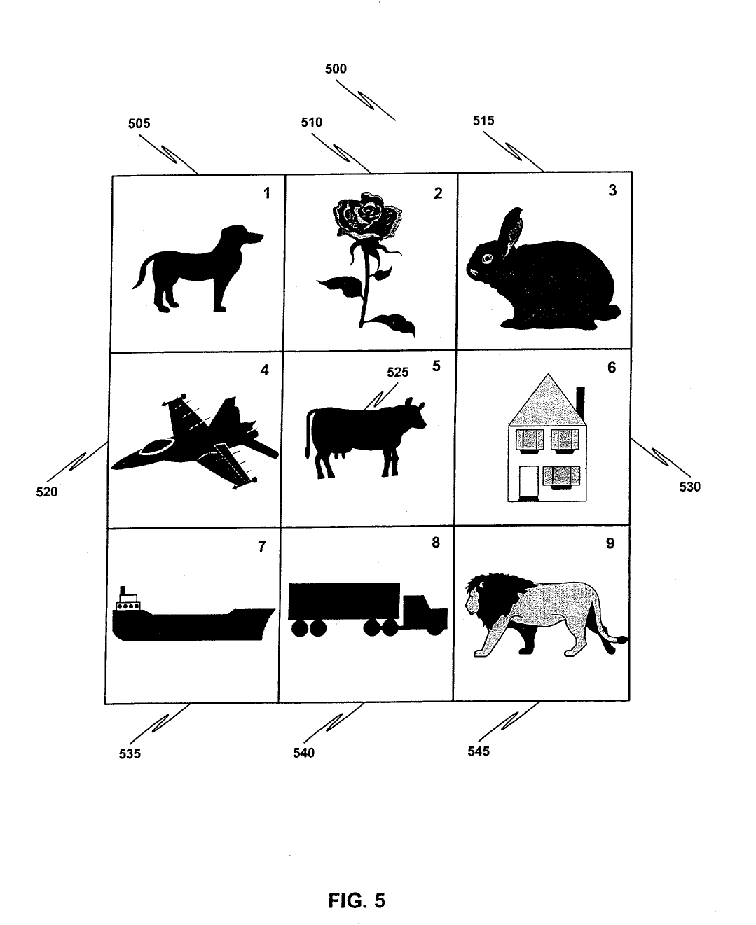

Turning now to FIG. 5, a block diagram that illustrates a composite image including superimposed entry tokens in accordance with one embodiment of the present invention is presented. Composite image 500 includes all the pictures of composite image 400 in FIG. 4, arranged differently. Given the same set of picture categories comprising a PIN, the entry token list entered in response to composite image 400 of FIG. 4 will differ from the entry token list entered in response to composite image 500 of FIG. 5. By way of example, if the PIN picture categories are the “dog”, “lion”, “plane” and “rabbit” categories and if all entry tokens must be entered in order, the required entry token list is “5-9-2-6” when presented with composite image 400 of FIG. 4. In contrast, the same user must enter “1-9-4-3” when presented with composite image 500 of FIG. 5.

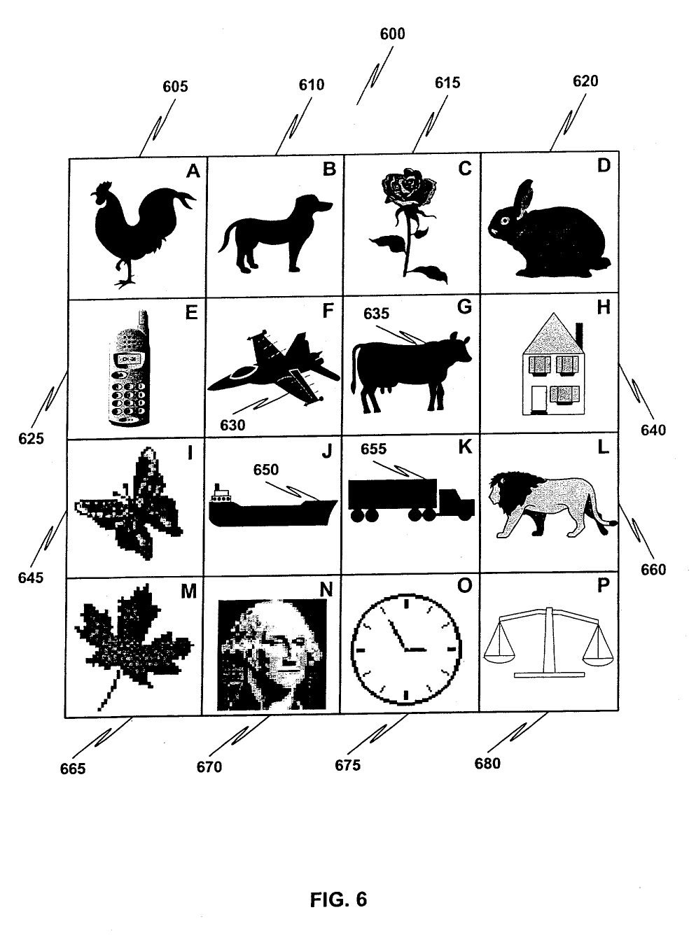

Turning now to FIG. 6, a block diagram that illustrates a composite image including superimposed entry tokens in accordance with one embodiment of the present invention is presented. FIG. 6 is similar to FIGS. 4 and 5 except that FIG. 6 includes a square grid of 16 pictures and a single character entry token references each of the pictures. Those of ordinary skill in the art will recognize that other orderings of pictures within composite pictures are possible. Those of ordinary skill in the art will also recognize that other associations between entry tokens and pictures are possible.

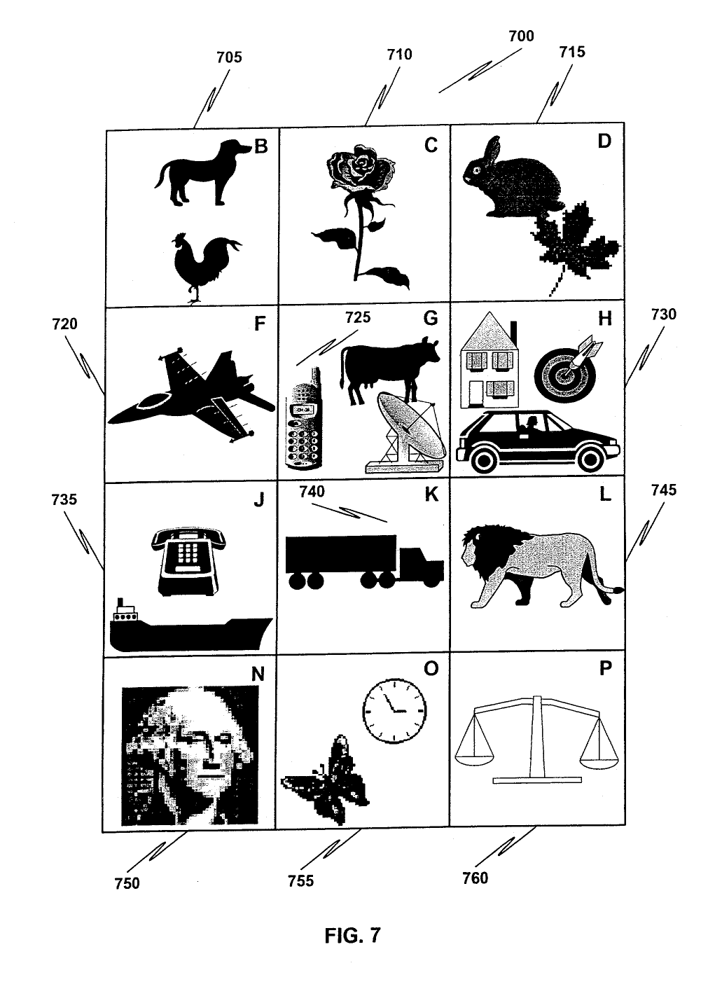

According to one embodiment of the present invention, a picture corresponds with a picture category if at least a sub-picture or part of the picture corresponds with the picture category. This is illustrated more with reference to FIG. 7.

Turning now to FIG. 7, a block diagram that illustrates a composite image including multiple sub-pictures within a picture in accordance with one embodiment of the present invention is presented. FIG. 7 is similar to FIG. 6 except that FIG. 7 includes a rectangular grid of 12 pictures including four rows of three pictures. FIG. 7 also includes multiple sub-pictures within pictures. Picture 705 corresponds with the “dog” and “rooster” picture categories. Picture 715 corresponds with the “rabbit” and “leaf” picture categories. Picture 725 corresponds with the “mobile phone”, “cow” and “satellite dish” categories. By way of example, a user whose PIN picture categories are “cow-dog-phone-lion” would enter the entry token list “G-B-G-L” when presented with composite image 700. The same entry token list would be entered if PIN picture categories were “mobile phone-rooster-satellite dish-lion”, since many of the pictures correspond to multiple categories.

According to another embodiment of the present invention, one or more picture categories overlap with other picture categories. For example, the “Animal” category may overlap with the “dog”, “lion”, “rabbit” and “cow” categories illustrated in FIG. 4. As a further example, suppose the PIN is “animal-rose-house”. In this case, the acceptable responses when presented with the image represented in FIG. 4 are the entry token lists: “1-4-3”, “5-4-3”, “6-4-3” and “9-4-3”.

According to another embodiment of the present invention, the number of PIN picture categories is less than the number of picture categories represented in the composite image presented to the user.

According to one embodiment of the present invention, the number of PIN picture categories is the same as the number of filler categories.

According to another embodiment of the present invention, the number of PIN picture categories is less than the number of filler categories.

According to another embodiment of the present invention, the number of PIN picture categories is greater than the number of filler categories.

According to one embodiment of the present invention, the number of PIN picture categories is four and the number of picture categories represented in the composite image presented to the user is nine.

According to one embodiment of the present invention, the number of PIN picture categories is four and the number of picture categories represented in the composite image presented to the user is sixteen.

According to embodiments of the present invention, when a user enrolls with a secure portable device, the user provides information that may be used to authenticate the user when the user makes an access request. By way of example, the user may provide his or her own pictures, picture categories, entry tokens, correspondence criteria or any combination thereof. These embodiments are described in more detail below.

According to another embodiment of the present invention, a user supplies at least one picture category during the enrollment process, when the user enrolls with the secure portable device. At least one picture corresponding to the at least one picture category is stored in a picture database for possible use when the user makes an access request. The at least one picture category may be, by way of example, a “My children” category or a “My siblings” category.

According to another embodiment of the present invention, a user supplies at least one PIN picture for at least one picture category during the enrollment process. The at least one PIN picture is stored in a picture database for possible use when the user makes an access request. The at least one PIN picture may be, by way of example, one or more pictures of the user's family.

According to another embodiment of the present invention, the user determines the correspondence criteria at enrollment. For example, the user may supply pictures of the user's children, their birth dates and the correspondence criteria to be such that when the user is presented with a composite image, the user must identify pictures of the users' children in the order of their birth.

According to another embodiment of the present invention, the user indicates at least one entry token to be superimposed on a picture at enrollment. For example, the user may indicate that the entry tokens comprise a set of numbers.

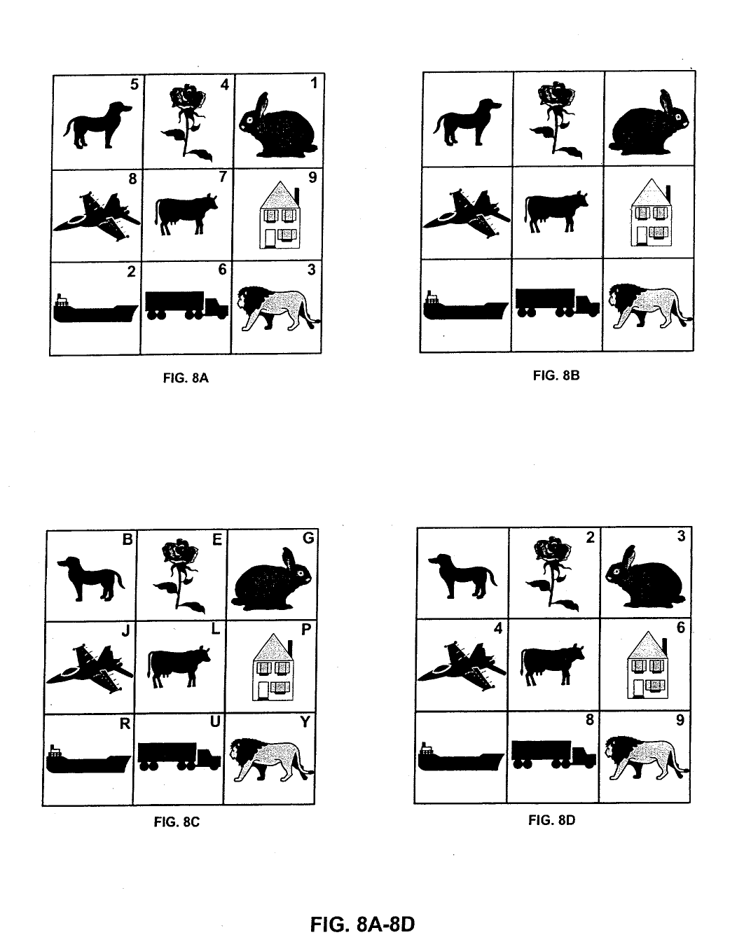

FIGS. 8A-8D illustrate different ways to indicate the association of a picture with an entry token in accordance with embodiments of the present invention.

Turning now to FIG. 8A, a block diagram that illustrates a composite image including randomized superimposed entry tokens in accordance with embodiments of the present invention is presented. According to one embodiment, the association between a particular picture and a randomized entry token is established by the picture category ID list provider (such as category selector 320 of FIG. 3). According to another embodiment, the association between a particular picture and a randomized entry token is established by the image generator (such as image generator 325 of FIG. 3) and the image generator provides the association information to the entity that compares the entry token correspondence list with the entry token list (such as PIN comparator 315 of FIG. 3).

Turning now to FIG. 8B, a block diagram that illustrates a composite image without superimposed entry tokens in accordance with one embodiment of the present invention is presented. The mapping between a picture and an entry token is established when the user enrolls with the secure portable device. For example, the agreed-upon association may be such that pictures are numbered sequentially from left to right and from top to bottom. Thus, when a user is presented with a composite image without superimposed entry tokens, the user identifies at least one PIN picture and associates it with an entry token based upon the agreed-upon mapping established at enrollment.

Turning now to FIG. 8C, a block diagram that illustrates a composite image including noncontiguous superimposed entry tokens in accordance with one embodiment of the present invention is presented. As shown in FIG. SC, the entry tokens are letters of the alphabet and they increase from left to right and from top to bottom, skipping one or more letters between adjacent pictures.

Turning now to FIG. 8D, a block diagram that illustrates a composite image including superimposed entry tokens on a subset of pictures in accordance with one embodiment of the present invention is presented. As shown in FIG. 7E, at least one picture has no superimposed entry token. The entry token for a picture that has no superimposed entry token may be inferred from entry tokens superimposed on other pictures in the same composite image.

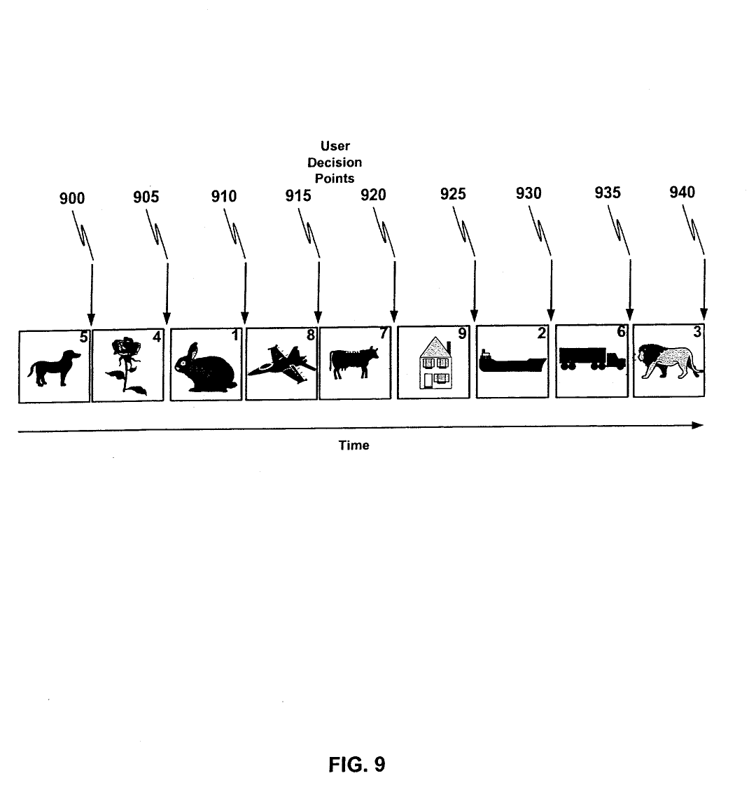

FIGS. 9-11 illustrate displaying pictures within a composite picture serially in accordance with embodiments of the present invention. Pictures comprising a composite image are presented in a piecemeal manner until the pictures that comprise the composite image have been displayed.

Turning now to FIG. 9, a block diagram that illustrates a composite image having pictures that are displayed serially in one-member groups in accordance with one embodiment of the present invention is presented. The user may indicate whether a picture is a PIN picture after each picture is presented (900-940). The user may provide a first response to indicate a picture is a PIN picture or a second response to indicate a picture is not a PIN picture. Upon providing a response, the user is presented with another picture in the composite picture. This process continues until a response has been received for each picture in the composite image (940). Alternatively, the user may indicate whether a picture is a PIN picture after all of the pictures have been presented (940).

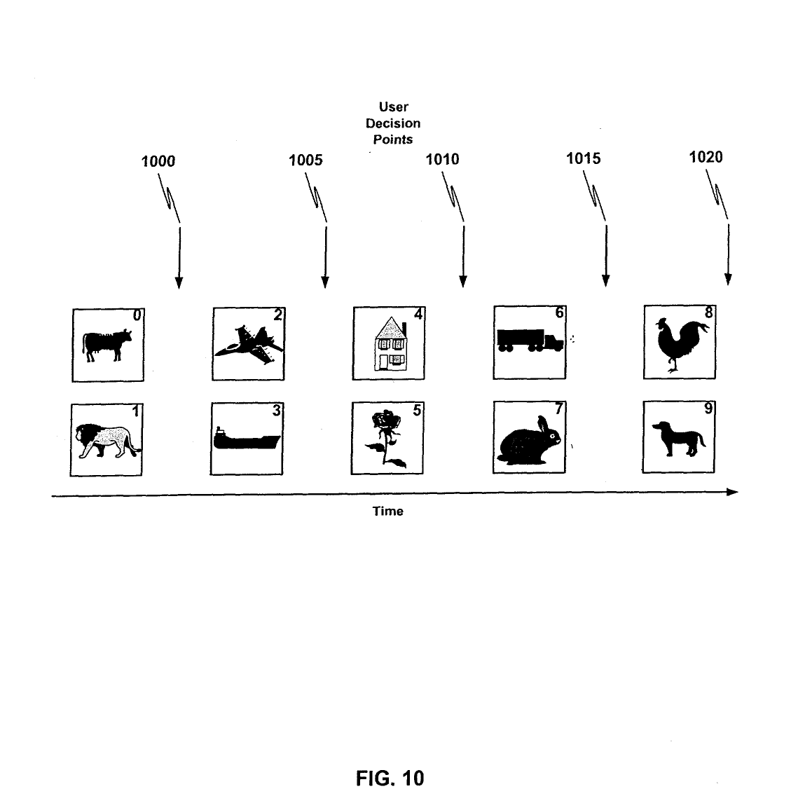

Turning now to FIG. 10, a block diagram that illustrates a composite image having pictures that are displayed serially in two-member groups in accordance with one embodiment of the present invention is presented. The user is presented with pictures comprising the composite image, two pictures at a time. The user may enter one or more entry token to indicate one or more of the two pictures are is a PIN picture. A separate entry token may be used to indicate none of the currently displayed pictures are PIN pictures, thus skipping to the next set of two pictures. Upon providing a response, the user is presented with another two pictures in the composite image. This process continues until all pictures in the composite image (1020) have been presented. Alternatively, the user may indicate whether a picture is a PIN picture after all of the pictures have been presented (1020).

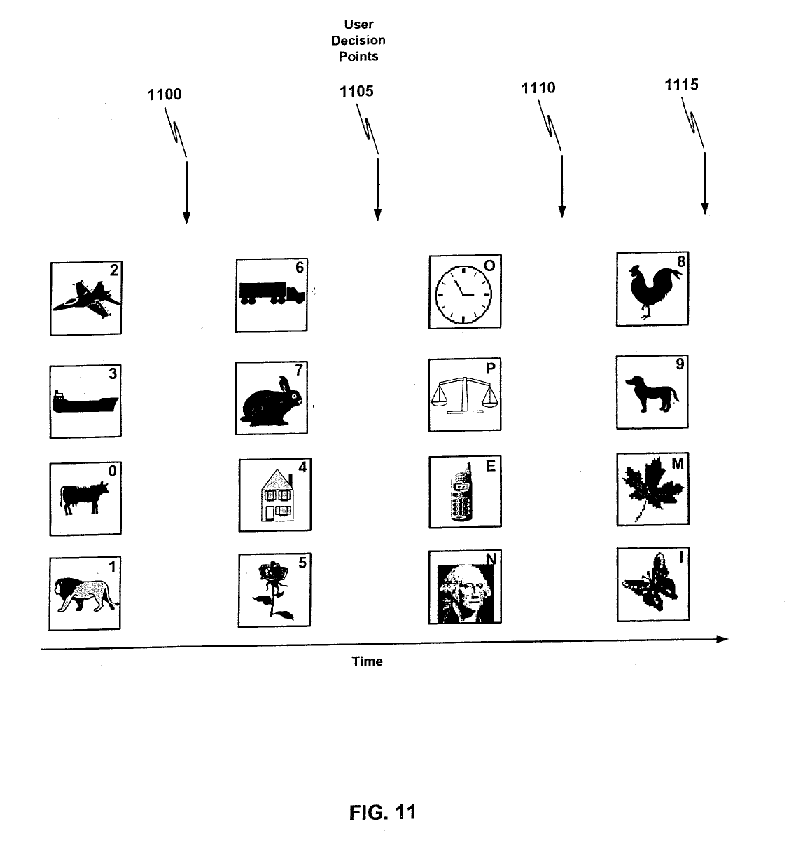

Turning now to FIG. 11, a block diagram that illustrates a composite image having pictures that are displayed serially in four-member groups in accordance with one embodiment of the present invention is presented. The user is presented with pictures comprising the composite image, four pictures at a time. The user may enter one or more entry token to indicate one or more of the four pictures are is a PIN picture. A separate entry token may be used to indicate none of the currently displayed pictures are PIN pictures, thus skipping to the next set of four pictures. Upon providing a response, the user is presented with another four pictures in the composite image. This process continues until all pictures in the composite image (1115) have been presented. Alternatively, the user may indicate whether a picture is a PIN picture after all of the pictures have been presented (1115).

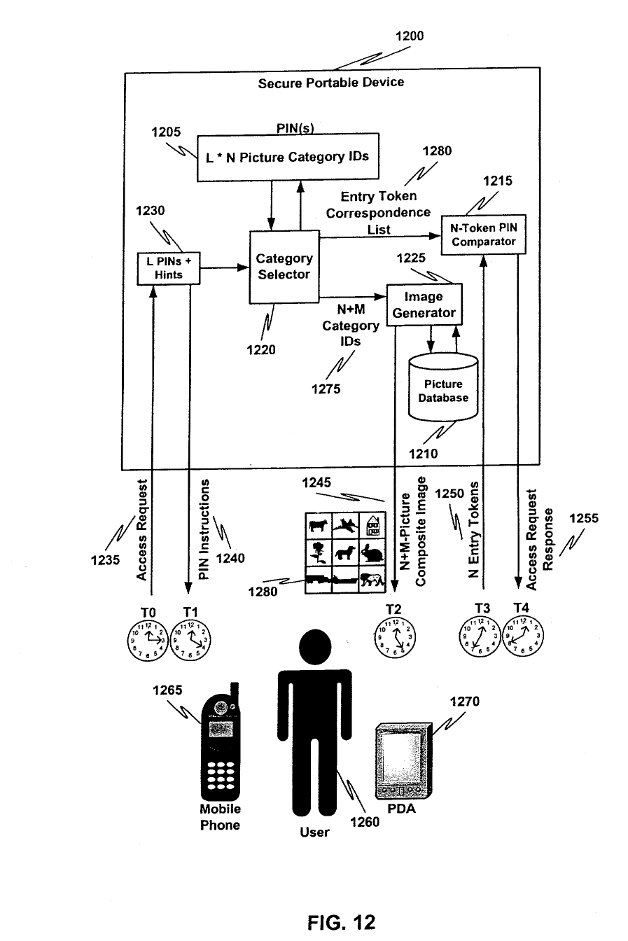

Turning now to FIG. 12, a block diagram that illustrates an integrated apparatus for dynamic PIN management that includes providing a user with PIN instructions in accordance with one embodiment of the present invention is presented. FIG. 12 is similar to FIG. 3 except that FIG. 12 includes a PIN selector 1230 for selecting a PIN from a group of one or more PINs and for sending PIN hints or instructions to a user 1260. Secure portable device 1200 includes at least one stored PIN 1205 that comprises one or more picture category IDs. Device 1200 also includes a picture database 1210 for storing categorized pictures and a category selector 1220 for selecting a picture category ID list 1275 and an entry token correspondence list 1280. Device 1200 also includes an image generator 1225 for generating a composite image 1280 that includes pictures corresponding to the picture categories selected by the category selector 1220. Secure portable device 1200 also includes a PIN comparator 1215 for comparing the entry token correspondence list 1280 with an entry token list 1250.

In operation, a user 1260 requests access to a service (1235). PIN selector 1230 receives the access request 1235 and selects a PIN that comprises at least one picture category ID. Category selector 1220 creates an entry token correspondence list 1280 that includes at least one entry token that corresponds with the at least one picture category ID in the selected PIN 1205. Category selector 1220 also creates a picture category ID list 1275 including picture category IDs comprising the selected PIN 1205. According to one embodiment of the present invention, the ordering of the picture categories IDs within the picture category ID list 1275 determines the order the corresponding pictures will be presented to the user 1260. The picture category ID list 1275 includes PIN picture category IDs and filler category IDs. Category selector 1220 presents the picture category ID list 1275 to image generator 1225. For each picture category ID in the picture category ID list 1275, the image generator 1225 selects a picture that belongs to the picture category from the picture database 1210. Image generator 1225 then combines the selected pictures into a composite image 1280. At 1240, PIN selector 1230 sends PIN instructions or hints to the user 1260. The instructions or hints provide information to help the user 1260 select the correct pictures in the correct order when presented with a composite image 1280.

Still referring to FIG. 12, at 1245 the composite image 1280 is presented to the user 1260. The composite image 1280 may be presented to the user 1260 via the user's mobile phone 1265, Personal Digital Assistant (PDA) 1270 or the like. The composite image 1280 may also be displayed to the user via the display device of a PC or workstation (not shown in FIG. 12). The user 1260 uses the PIN instructions or hints 1240 to identify PIN pictures within the composite image 1280. At 1250 the user 1260 provides an entry token list 1250 by entering entry tokens corresponding to the PIN pictures within the composite image 1280. PIN comparator 1215 receives the entry token correspondence list 1280 from category selector 1220. PIN comparator 1215 also receives the entry token list 1250 and compares it to the entry token correspondence list 1280. If the lists match, access to the service is granted at 1255. If the lists do not match, access to the service is denied at 1255.

According to one embodiment of the present invention, PIN selector 1230 selects a PIN from a preconfigured group of PINs and includes the name of the PIN or other prearranged reference to the PIN in the PIN instructions 1240 sent to the user 1260. The preconfigured group of PINs may be established when the user 1260 enrolls with the secure portable device 1200. For example, suppose the user 1260 establishes three PINs at enrollment: an “Animal” PIN including various “animal” picture category IDs, a “Furniture” PIN including various “furniture” picture category IDs and a “People” PIN including various “people” picture category IDs. In this case, the PIN selector 1230 may select one of the preconfigured PINs and include the PIN name in the PIN instructions to the user 1260.

According to another embodiment of the present invention, the PIN instructions 1240 indicate a PIN by picture category. For example, the instructions 1240 may direct the user 1260 to identify four pictures that include depictions of a horse, a dog, a tree and a car, respectively.

According to another embodiment of the present invention, the PIN instructions 1240 indicate a PIN by picture category and an entry order of the entry token identifying the PIN picture in the composite picture. Using the example above, the instructions may direct the user 1260 to identify four pictures that include depictions of a horse, a dog, a tree and a car, respectively. The instructions 1240 may further instruct the user 1260 to identify the pictures in reverse order (car-tree-dog-horse).

According to another embodiment of the present invention, the same PIN instructions 1240 are provided every time an access request 1235 is received. Those of ordinary skill in the art will recognize that other instructions are possible.

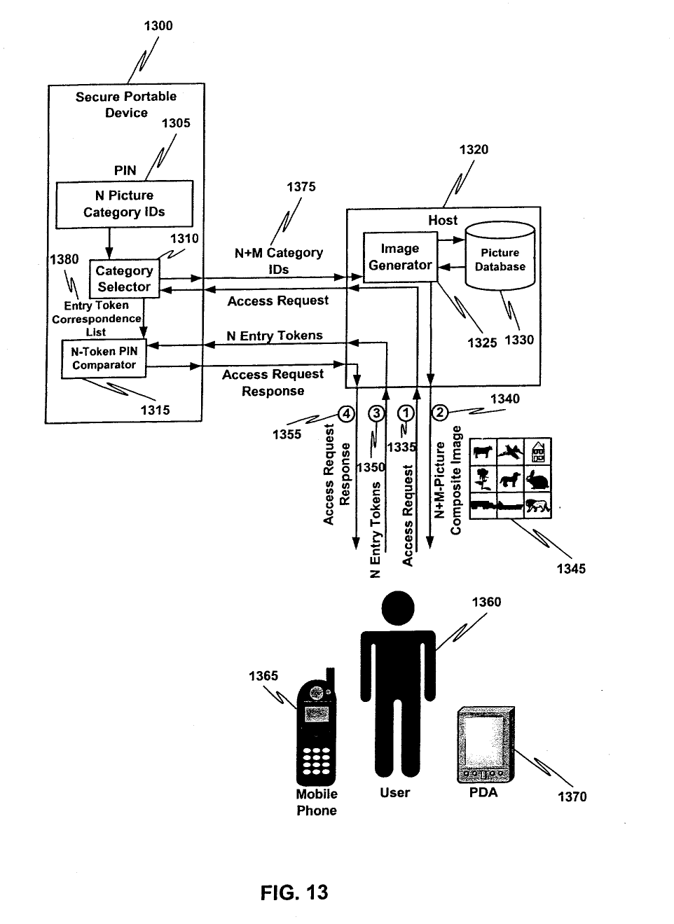

Turning now to FIG. 13, a block diagram that illustrates a distributed apparatus for dynamic PIN management in accordance with one embodiment of the present invention is presented. Secure portable device 1300 includes a stored PIN 1305 that comprises one or more picture category IDs. Secure portable device 1300 also includes a category selector 1310 for selecting a picture category ID list 1375 and an entry token correspondence list 1380. Secure portable device 1300 also includes a PIN comparator 1315 for comparing an entry token list 1350 with the entry token correspondence list 1380.

Host 1320 includes a picture database 1330 for storing categorized pictures and an image generator 1325 for generating a composite image 1345 that includes pictures corresponding to the picture categories selected by category selector 1310 of secure portable device 1300. According to one embodiment of the present invention, host 1320 comprises a mobile phone. According to one embodiment of the present invention, host 1320 comprises a Web server.

In operation, user 1360 requests access to a service (1335). Host 1320 receives the access request 1335 and forwards the request 1335 to secure portable device 1300. Category selector 1310 in secure portable device 1300 receives the access request 1335 and creates a picture category ID list 1375. According to one embodiment of the present invention, the ordering of the picture categories IDs within the picture category ID list 1375 determines the order the corresponding pictures will be presented to the user 1360. The picture category ID list 1375 includes PIN picture category IDs and filler category IDs. Category selector 1310 creates an entry token correspondence list 1380 that includes at least one entry token that corresponds with the at least one picture category ID in the PIN 1305. Category selector 1310 also creates a picture category ID list 1375 including picture category IDs comprising the PIN 1305. Category selector 1310 sends the picture category ID list 1375 to host 1320. Image generator 1325 in host 1320 receives the picture category ID list 1375. For each picture category ID in the picture category ID list 1375, the image generator 1325 selects a picture that belongs to the picture category from the picture database 1330. Image generator 1325 then combines the selected pictures into a composite image 1345. According to one embodiment of the present invention, the positioning of pictures within the composite image 1345 is based upon the corresponding picture category ID's position in the picture category ID list 1375. At 1340 the composite image 1345 is presented to the user 1360. At 1350 the user 1360 enters entry tokens corresponding to pictures within the composite image 1345. Host 1320 forwards the entry token list 1350 to secure portable device 1300. PIN comparator 1315 in secure portable device 1300 receives the entry token correspondence list 1380 from category selector 1310. PIN comparator 1315 also receives the entry token list 1350 and compares it to the entry token correspondence list 1380. If the lists match, access to the service is granted at 1355. If the lists do not match, access to the service is denied at 1355.

According to another embodiment of the present invention, secure portable device 1300 provides the user 1360 with PIN instructions or hints upon receiving the access request 1355. The user 1360 uses the PIN instructions or hints to identify PIN pictures within the composite image 1345.

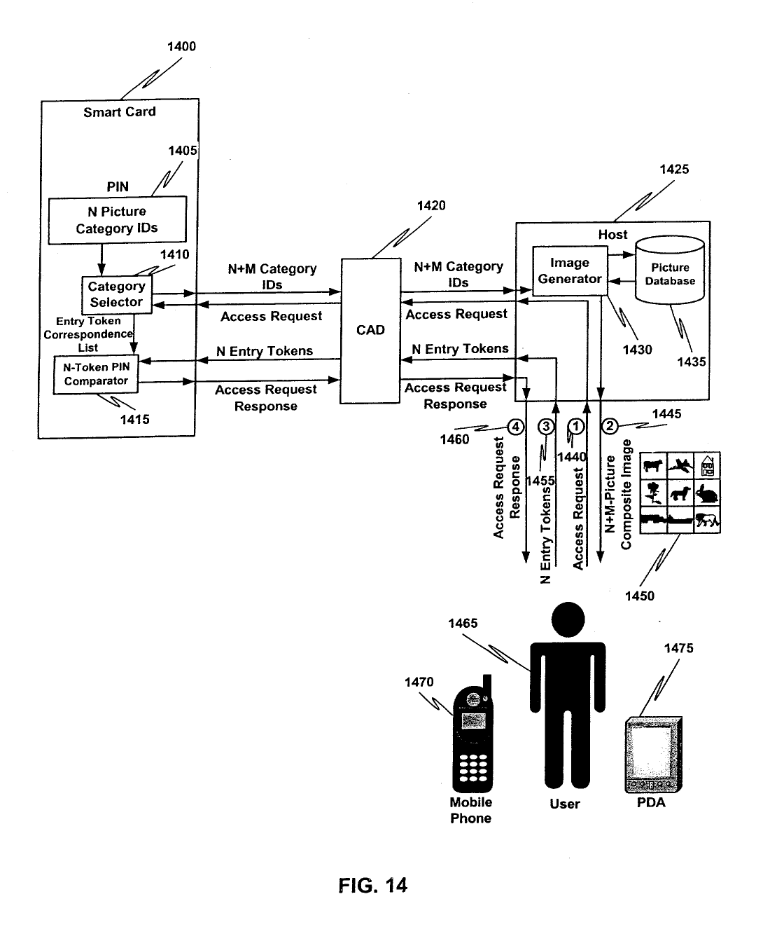

Turning now to FIG. 14, a block diagram that illustrates a distributed apparatus for dynamic PIN management using a smart card 1400 in accordance with one embodiment of the present invention is presented. FIG. 14 is similar to FIG. 13 except that the secure portable device 1300 of FIG. 13 corresponds to a smart card 1400 in FIG. 14. The smart card 1400 interfaces with host 1425 via a card acceptance device (CAD) 1420.

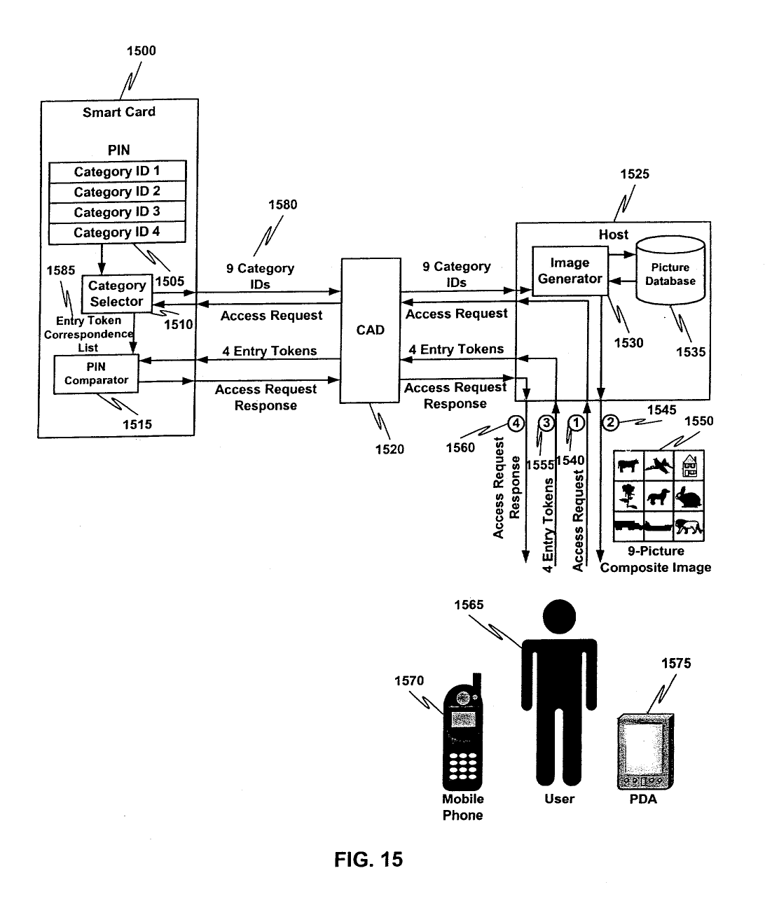

Turning now to FIG. 15, a block diagram that illustrates a distributed apparatus for dynamic PIN management using a smart card in accordance with one embodiment of the present invention is presented. FIG. 15 is a more detailed form of FIG. 14. FIG. 15 illustrates an embodiment where the user 1565 is presented with a composite image 1550 comprising nine pictures and the user 1565 must choose four of the pictures. For example, suppose the PIN picture categories are the “dog”, “rabbit”, “house” and “lion” categories. In this case, the stored PIN 1505 comprises the four PIN picture category IDs that correspond to the “dog”, “rabbit”, “house” and “lion” picture categories. When category selector 1510 receives an access request 1540, it determines the filler category IDs and the display order for all pictures. In the present example, the filler categories are the “cow”, “plane”, “flower”, “truck” and “ship” categories. Category selector 1510 creates an entry token correspondence list 1585 that includes at least one entry token that corresponds with the at least one picture category ID in the PIN 1505. Category selector 1510 also creates a list of the nine picture category IDs (1580) and sends the picture category ID list 1580 to the host 1525. The picture category ID list 1580 in the present example is “cow-plane-house-flower-dog-rabbit-truck-ship-lion”.

Still referring to FIG. 15, image generator 1530 in host 1525 receives the picture category ID list 1580 and generates a composite image 1550 that includes pictures belonging to the picture categories in the picture category ID list 1580 and ordered according to the order specified by the picture category ID list 1580. The composite image 1550 is presented to the user 1565 at 1545. The user 1565 selects pictures according to the agreed-upon PIN. If the agreed-upon PIN specifies that the order of the pictures matters, the user 1565 must enter the entry tokens in the agreed-upon order. For example, if the agreed-upon order is “dog-rabbit-house-lion” and if composite image 1550 is numbered according to FIG. 4, the user 1565 enters “5-6-3-9”. If the composite image 1550 is numbered according to FIG. 5 and order matters, the user 1565 enters “1-3-6-9”. If order does not matter, the four numbers may be entered in any order.

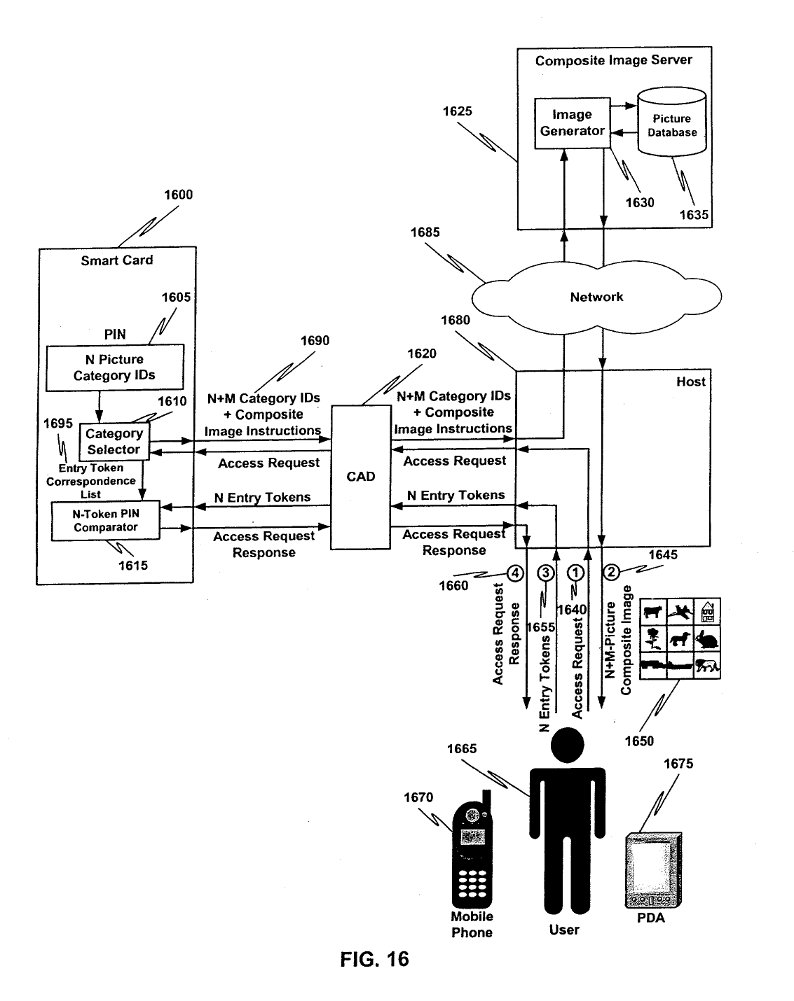

According to embodiments of the present invention, at least one composite image instruction is included with a picture category ID list 1580. The at least one composite image instruction may indicate entry tokens to superimpose over one or more pictures in the composite image 1550. The at least one composite image instruction may also identify a preconfigured set of composite image instructions maintained by the image generator 1530. This is explained in more detail below with reference to FIG. 16.

Turning now to FIG. 16, a block diagram that illustrates a distributed apparatus for dynamic PIN management using a smart card and a separate composite image server in accordance with one embodiment of the present invention is presented. FIG. 16 is similar to FIG. 14 except that FIG. 16 includes a separate composite image server 1625 in communication with the host 1680 via a network 1685. According to one embodiment of the present invention, host 1680 comprises a mobile phone. According to another embodiment of the present invention, host 1680 comprises a Web server. The composite image server 1625 generates composite images 1650 in response to instructions from host 1680. FIG. 16 also illustrates the inclusion of composite image instructions with the picture category ID list 1690 sent by a secure portable device such as a smart card 1600.

In operation, user 1665 requests access to a service (1640). Host 1680 receives the access request 1640 and forwards the request 1640 to smart card 1600. Category selector 1610 in smart card 1600 receives the access request 1640 and creates an entry token correspondence list 1695 that includes at least one entry token that corresponds with the at least one picture category ID in the PIN 1605. Category selector 1610 also creates a picture category ID list and at least one composite image instruction 1690. Category selector 1610 sends the picture category ID list and at least one composite image instruction 1690 to host 1680. Host 1680 receives the picture category ID list and the at least one composite image instruction 1690 and forwards them to image generator 1630 in composite image server 1625. For each picture category ID in the picture category ID list 1690, the image generator 1630 selects a picture that belongs to the picture category from the picture database 1635. Image generator 1630 then combines the selected pictures into a composite image 1650 based upon the at least one composite image instruction 1690. Image generator 1630 forwards the composite image 1650 to host 1680. At 1645, host 1680 presents the composite image 1650 to the user 1665. At 1655 the user 1665 enters entry tokens corresponding to pictures within the composite image 1650. Host 1680 forwards the entry token list to the smart card 1600. PIN comparator 1615 in smart card 1600 receives the entry token correspondence list 1695 from category selector 1610. PIN comparator 1615 also receives the entry token list 1655 and compares it to the entry token correspondence list 1695. If the lists match, access to the service is granted at 1660. If the lists do not match, access to the service is denied at 1660.

According to another embodiment of the present invention, smart card 1600 provides the user 1665 with PIN instructions or hints upon receiving the access request 1640. The user 1665 uses the PIN instructions or hints to identify PIN pictures within the composite image 1650.

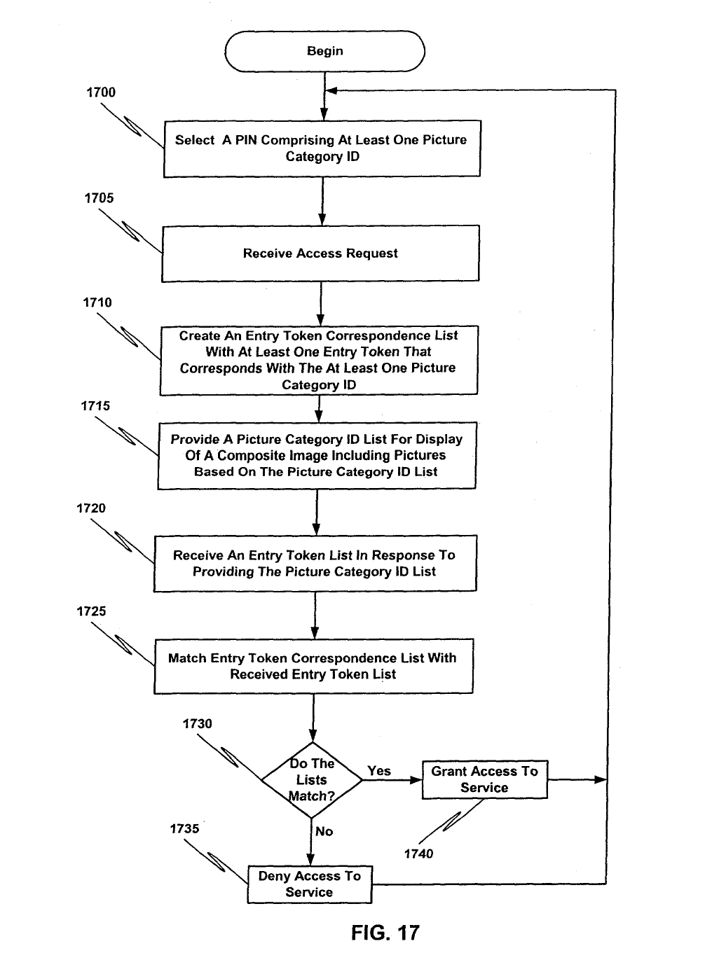

Turning now to FIG. 17, a flow diagram that illustrates a method for dynamic PIN management in accordance with one embodiment of the present invention is presented. At 1700, a PIN comprising at least one picture category ID is created. The PIN creation may be part of an enrollment process whereby a user authenticates himself or herself to a secure portable device that maintains the PIN. The user interfaces with the secure portable device to establish an agreed-upon one or more PIN picture categories.

At 1705 an access request is received. At 1710, an entry token correspondence list is created. The entry token correspondence list includes at least one entry token that corresponds with the at least one picture category ID in the PIN. If the one or more PIN picture category IDs comprises more than one category ID, the correspondence criteria may indicate a required order of entry tokens in an entry token list. In other words, The required order defines the order in which an entry token corresponding to a picture must be entered. For example, for a PIN comprising four PIN categories, if the PIN picture categories are the “dog”, “cat”, “house” and “flower” categories, an exemplary entry order is “dog-cat-house-flower”. This particular entry order requires that when a user is presented with a composite image comprising multiple pictures where each of the pictures is associated with an entry token, the user must enter the entry token for a picture including a dog, followed by the entry token for a picture including a cat, followed by the entry token for a picture including a house, followed by the entry token for a picture including a flower. Those of ordinary skill in the art will recognize that other required entry orders are possible.

Still referring to FIG. 17, at 1715 a picture category ID list is provided for displaying a composite image including pictures based on the picture category ID list. The picture category ID list includes the picture category IDs comprising the PIN. According to one embodiment of the present invention, the at least one composite image instruction is provided along with the picture category ID list. At 1720, an entry token list is received in response to providing the picture category ID list. At 1725, the entry token correspondence list is matched with the entry token list. At 1730, a determination is made regarding whether the two lists match. If the lists match, access to the service is granted at 1740. If the lists do not match, access to the service is denied at 1735.

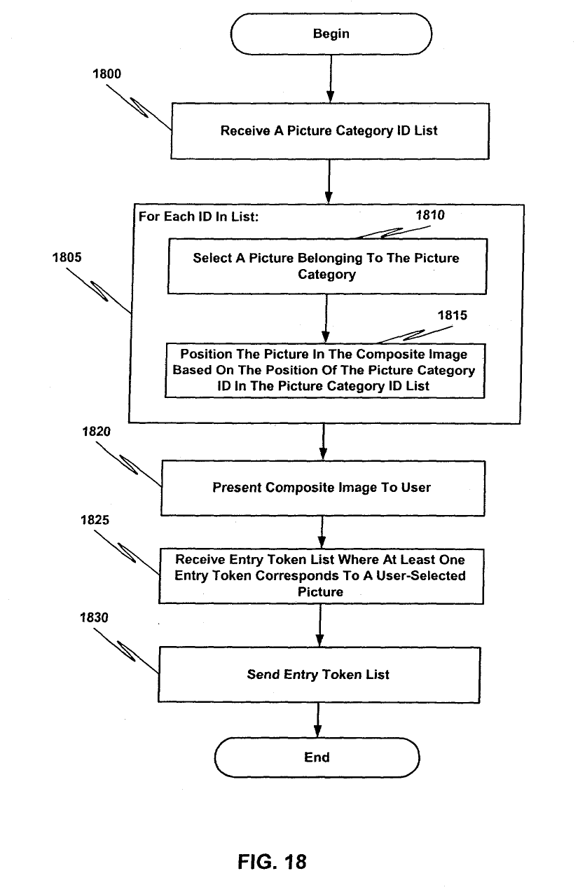

Turning now to FIG. 18, a flow diagram that illustrates a method for dynamic PIN management in accordance with one embodiment of the present invention is presented. At 1800, a picture category ID list is received. At 1810, a picture is selected for each picture category ID in the picture category ID list. The pictures may be selected from a database that includes categorized pictures. If more than one picture shares that same picture category, a randomized process may be used to determine which picture is selected. At 1815, each of the selected pictures is positioned in a composite image based on the position of the picture category ID in the picture category ID list. At 1820, the composite image is presented to a user. At 1825, an entry token list is received, where at least one entry token corresponds to a position within the composite image of a user-selected picture. At 1830, the entry token list is provided for use in determining whether the user-selected pictures match the PIN picture categories.

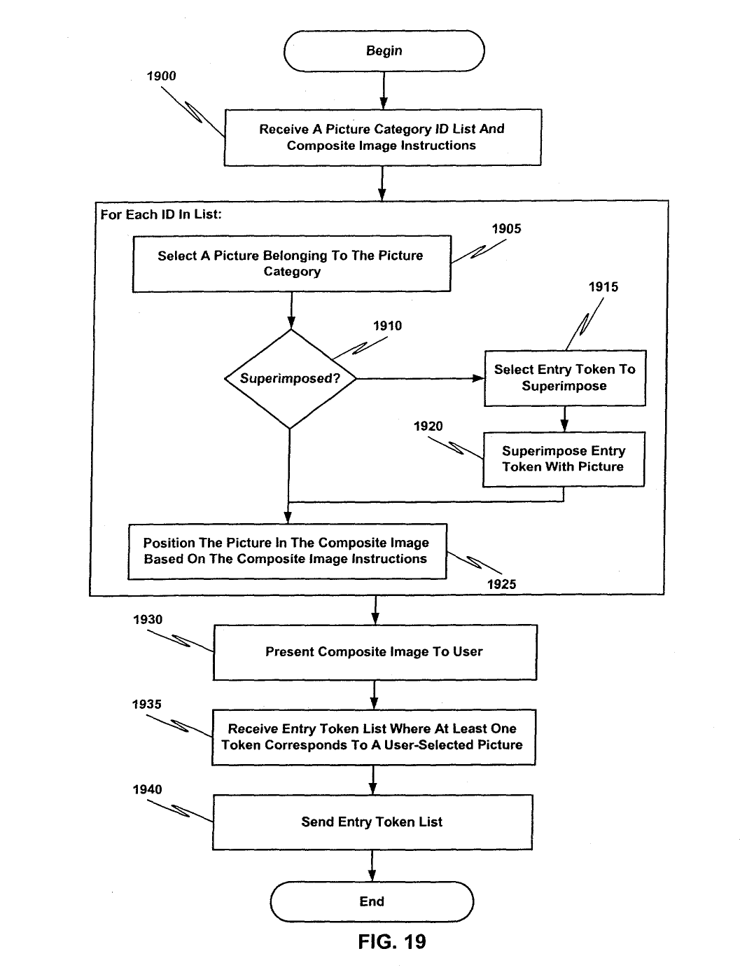

Turning now to FIG. 19, a flow diagram that illustrates a method for dynamic PIN management in accordance with one embodiment of the present invention is presented. At 1900, a picture category ID list and at least one composite image instruction is received. At 1905, a picture is selected for each picture category ID in the picture category ID list. The pictures may be selected from a database that includes categorized pictures. If more than one picture shares that same picture category, a randomized process may be used to determine which picture is selected. At 1910, a determination is made regarding whether an entry token needs to be superimposed on the picture. The at least one composite image instruction may indicate an entry token needs to be superimposed on the picture. Alternatively, the entry tokens to be superimposed may be preconfigured. If an entry token needs to be superimposed on the picture, an entry token is selected at 1915 and superimposed on the picture at 1920. At 1925, each of the selected pictures is positioned in a composite image based on the at least one composite image instruction. At 1930, the composite image is presented to a user. At 1935, an entry token list is received, where at least one entry token corresponds to a user-selected picture. At 1940, the entry token list is provided for use in determining whether the user-selected pictures match the PIN picture categories.

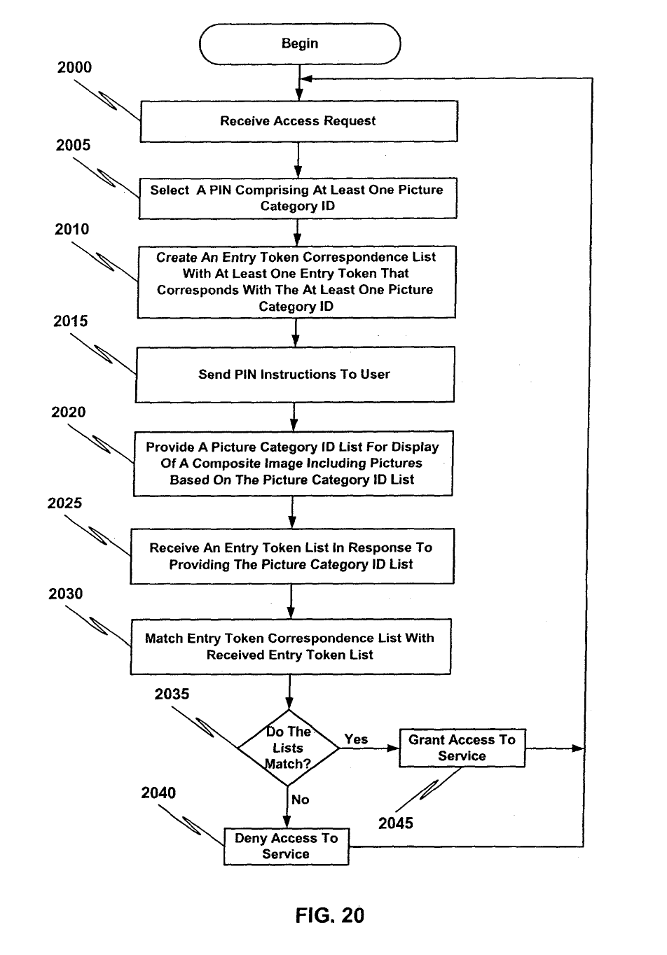

Turning now to FIG. 20, a flow diagram that illustrates a method for dynamic PIN management that includes providing a user with PIN instructions in accordance with one embodiment of the present invention is presented. FIG. 20 corresponds with FIG. 8. FIG. 20 is similar to FIG. 17, except that FIG. 20 includes sending PIN instructions or hints to a user (2015) before the user selects one or more pictures within the composite image. At 2000, a request for access to a service is received. At 2005, a PIN comprising at least one picture category ID is created. At 2010, an entry token correspondence list is created. The entry token correspondence list includes at least one entry token that corresponds with the at least one picture category ID in the PIN. At 2015, PIN instructions are sent to the user. The instructions or hints provide information to help the user select the correct pictures in the correct order when presented with a composite image. At 2020, a picture category ID list is provided for displaying a composite image including pictures based on the picture category ID list. The picture category ID list includes the picture category IDs comprising the PIN. At 2025, an entry token list is received where at least one entry token corresponds to a position within the composite image of a user-selected picture. At 2030, the entry token correspondence list is matched with the entry token list. At 2035, a determination is made regarding whether the two lists match. If the lists match, access to the service is granted at 2045. If the lists do not match, access to the service is denied at 2040.

Embodiments of the present invention have a number of advantages. The PIN is dynamic and thus hard to predict, making the PIN more secure. Eliminating the need to remember a numeric PIN also benefits people who have difficulty remembering numbers. The difficulty in predicting a PIN also obviates the need for an expensive CAD certification process.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for dynamic personal identification number (PIN) management, the method comprising:
selecting a PIN comprising at least one picture category ID;
determining a correspondence between at least one entry token and said at least one picture category ID;
creating a picture category ID list in response to an access request, said picture category ID list including said at least one picture category ID;
providing said picture category ID list for displaying a composite image including at least one picture based on said picture category ID list;
receiving an entry token list in response to said providing; and
granting said access request based upon whether at least one entry token in said entry token list corresponds to said at least one picture category ID.

2. The method of claim 1 wherein said entry token list comprises at least one character.

3. The method of claim 1 wherein said entry token list comprises at least one number.

4. The method of claim 1 wherein said entry token list comprises at least one letter.

5. The method of claim 1 wherein said entry token list comprises at least one non-alphanumeric symbol.

6. The method of claim 1 wherein said selecting comprises selecting a PIN from a plurality of PINs.

7. The method of claim 1 wherein said creating further comprises using a randomized process to determine the position of said at least one picture category ID within said picture category ID list.

8. The method of claim 1 wherein said creating further comprises using a randomized process to determine the position of picture categories other than said least one picture category ID within said picture category ID list.

9. The method of claim 1 wherein said creating further comprises using a randomized process to select picture categories other than said at least one picture category ID within said picture category ID list.

10. The method of claim 1 wherein the number of picture categories in said PIN is less than the number of picture categories in said picture category ID list.

11. The method of claim 10 wherein
said PIN comprises four picture categories; and
said picture category ID list comprises nine picture categories.

12. The method of claim 10 wherein
said PIN comprises four picture categories; and
said picture category ID list comprises sixteen picture categories.

13. The method of claim 1 wherein said granting further comprises granting said access request based on said correspondence and said entry token list.

14. The method of claim 1 wherein said granting further comprises granting said access request if each picture category in said PIN is represented by an entry token in said entry token list.

15. The method of claim 1 wherein said correspondence indicates a required order for entry tokens in said entry token list.

16. The method of claim 1 wherein
said creating further comprises associating each of said picture categories in said PIN with an entry token; and
said granting further comprises granting said access request if each entry token in said entry token list matches the entry token associated with the corresponding picture category ID of the PIN.

17. The method of claim 1 wherein said granting further comprises granting said access request if at least one but less than all of said entry tokens in said entry token list correspond to a picture category in said PIN.

18. The method of claim 1 wherein said method further comprises sending at least one PIN instruction in response to said request.

19. The method of claim 18 wherein said at least one PIN instruction comprises at least one picture category ID.

20. The method of claim 18 wherein said at least one PIN instruction comprises a required picture category sequence.

21. The method of claim 18, further comprising repeating said at least one PIN instruction for successive access requests.

22. The method of claim 1, further comprising receiving from a user at least one picture belonging to said at least one picture category ID.

23. The method of claim 1, further comprising receiving from a user said at least one picture category.

24. The method of claim 1, further comprising receiving from a user said correspondence.

25. The method of claim 1 wherein
said creating further comprises creating at least one composite image instruction; and
said providing further comprises providing said composite image instruction for use in generating said composite image.

26. The method of claim 25 wherein said at least one composite image instruction indicates that the position of each picture category ID in said picture category ID list determines the position of a corresponding picture in said composite image.

27. The method of claim 1 wherein said displaying comprises presenting each picture in said composite image serially.

28. The method of claim 27 wherein said displaying comprises presenting pictures comprising said composite image serially in groups of two pictures.

29. The method of claim 27 wherein said displaying comprises presenting pictures comprising said composite image serially in groups of four pictures.

30. The method of claim 25 wherein said at least one composite image instruction indicates at least one entry token to be superimposed on a picture corresponding to a picture category ID in said picture category ID list.

31. A program storage device readable by a machine, embodying a program of instructions executable by the machine to perform a method for dynamic personal identification number (PIN) management, the method comprising:
selecting a PIN comprising at least one picture category ID;
determining a correspondence between at least one entry token and said at least one picture category ID;
creating a picture category ID list in response to an access request, said picture category ID list including said at least one picture category ID;
providing said picture category ID list for displaying a composite image including at least one picture based on said picture category ID list;
receiving an entry token list in response to said providing; and
granting said access request based upon whether at least one entry token in said entry token list corresponds to said at least one picture category ID.

32. The program storage device of claim 31 wherein said entry token list comprises at least one character.

33. The program storage device of claim 31 wherein said entry token list comprises at least one number.

34. The program storage device of claim 31 wherein said entry token list comprises at least one letter.

35. The program storage device of claim 31 wherein said entry token list comprises at least one non-alphanumeric symbol.

36. The program storage device of claim 31 wherein said selecting comprises selecting a PIN from a plurality of PINs.

37. The program storage device of claim 31 wherein said creating further comprises using a randomized process to determine the position of said at least one picture category ID within said picture category ID list.

38. The program storage device of claim 31 wherein said creating further comprises using a randomized process to determine the position of picture categories other than said least one picture category ID within said picture category ID list.

39. The program storage device of claim 31 wherein said creating further comprises using a randomized process to select picture categories other than said at least one picture category ID within said picture category ID list.

40. The program storage device of claim 31 wherein the number of picture categories in said PIN is less than the number of picture categories in said picture category ID list.

41. The program storage device of claim 40 wherein
said PIN comprises four picture categories; and
said picture category ID list comprises nine picture categories.

42. The program storage device of claim 40 wherein
said PIN comprises four picture categories; and
said picture category ID list comprises sixteen picture categories.

43. The program storage device of claim 31 wherein said granting further comprises granting said access request based on said correspondence and said entry token list.

44. The program storage device of claim 31 wherein said granting further comprises granting said access request if each picture category in said PIN is represented by an entry token in said entry token list.

45. The program storage device of claim 31 wherein said correspondence indicates a required order for entry tokens in said entry token list.

46. The program storage device of claim 31 wherein
said creating further comprises associating each of said picture categories in said PIN with an entry token; and
said granting further comprises granting said access request if each entry token in said entry token list matches the entry token associated with the corresponding picture category ID of the PIN.

47. The program storage device of claim 31 wherein said granting further comprises granting said access request if at least one but less than all of said entry tokens in said entry token list correspond to a picture category in said PIN.

48. The program storage device of claim 31 wherein said method further comprises sending at least one PIN instruction in response to said request.

49. The program storage device of claim 48 wherein said at least one PIN instruction comprises at least one picture category ID.

50. The program storage device of claim 48 wherein said at least one PIN instruction comprises a required picture category sequence.

51. The program storage device of claim 48, further comprising repeating said at least one PIN instruction for successive access requests.

52. The program storage device of claim 31, further comprising receiving from a user at least one picture belonging to said at least one picture category ID.

53. The program storage device of claim 31, further comprising receiving from a user said at least one picture category.

54. The program storage device of claim 31, further comprising receiving from a user said correspondence.

55. The program storage device of claim 31 wherein
said creating further comprises creating at least one composite image instruction; and
said providing further comprises providing said composite image instruction for use in generating said composite image.

56. The program storage device of claim 55 wherein said at least one composite image instruction indicates that the position of each picture category ID in said picture category ID list determines the position of a corresponding picture in said composite image.

57. The program storage device of claim 31 wherein said displaying comprises presenting each picture in said composite image serially

58. The program storage device of claim 57 wherein said displaying comprises presenting pictures comprising said composite image serially in groups of two pictures.

59. The program storage device of claim 57 wherein said displaying comprises presenting pictures comprising said composite image serially in groups of four pictures.

60. The program storage device of claim 55 wherein said at least one composite image instruction indicates at least one entry token to be superimposed on a picture corresponding to a picture category ID in said picture category ID list.

61. An apparatus for dynamic personal identification number (PIN) management, the apparatus comprising:
means for selecting a PIN comprising at least one picture category ID;
means for determining a correspondence between at least one entry token and said at least one picture category ID;
means for creating a picture category ID list in response to an access request, said picture category ID list including said at least one picture category ID;
means for providing said picture category ID list for displaying a composite image including at least one picture based on said picture category ID list;
means for receiving an entry token list in response to said providing; and
means for granting said access request based upon whether at least one entry token in said entry token list corresponds to said at least one picture category ID.

62. The apparatus of claim 61 wherein said entry token list comprises at least one character.

63. The apparatus of claim 61 wherein said entry token list comprises at least one number.

64. The apparatus of claim 61 wherein said entry token list comprises at least one letter.

65. The apparatus of claim 61 wherein said entry token list comprises at least one non-alphanumeric symbol.

66. The apparatus of claim 61 wherein said selecting comprises means for selecting a PIN from a plurality of PINs.

67. The apparatus of claim 61 wherein said means for creating further comprises means for using a randomized process to determine the position of said at least one picture category ID within said picture category ID list.

68. The apparatus of claim 61 wherein said means for creating further comprises means for using a randomized process to determine the position of picture categories other than said least one picture category ID within said picture category ID list.

69. The apparatus of claim 61 wherein said means for creating further comprises means for using a randomized process to select picture categories other than said at least one picture category ID within said picture category ID list.

70. The apparatus of claim 61 wherein the number of picture categories in said PIN is less than the number of picture categories in said picture category ID list.

71. The apparatus of claim 70 wherein
said PIN comprises four picture categories; and
said picture category ID list comprises nine picture categonies.

72. The apparatus of claim 70 wherein
said PIN comprises four picture categories; and
said picture category ID list comprises sixteen picture categories.

73. The apparatus of claim 61 wherein said means for granting further comprises means for granting said access request based on said correspondence and said entry token list.

74. The apparatus of claim 61 wherein said means for granting further comprises means for granting said access request if each picture category in said PIN is represented by an entry token in said entry token list.

75. The apparatus of claim 61 wherein said correspondence indicates a required order for entry tokens in said entry token list.

76. The apparatus of claim 61 wherein
said means for creating further comprises means for associating each of said picture categories in said PIN with an entry token; and
said means for granting further comprises means for granting said access request if each entry token in said entry token list matches the entry token associated with the corresponding picture category ID of the PIN.

77. The apparatus of claim 61 wherein said means for granting further comprises means for granting said access request if at least one but less than all of said entry tokens in said entry token list correspond to a picture category in said PIN.

78. The apparatus of claim 61 wherein said apparatus further comprises means for sending at least one PIN instruction in response to said request.

79. The apparatus of claim 78 wherein said at least one PIN instruction comprises at least one picture category ID.

80. The apparatus of claim 78 wherein said at least one PIN instruction comprises a required picture category sequence.

81. The apparatus of claim 78, further comprising means for repeating said at least one PIN instruction for successive access requests.

82. The apparatus of claim 61, further comprising means for receiving from a user at least one picture belonging to said at least one picture category ID.

83. The apparatus of claim 61, further comprising means for receiving from a user said at least one picture category.

84. The apparatus of claim 61, further comprising means for receiving from a user said correspondence.

85. The apparatus of claim 61 wherein
said means for creating further comprises means for creating at least one composite image instruction; and
said means for providing further comprises means for providing said composite image instruction for use in generating said composite image.

86. The apparatus of claim 85 wherein said at least one composite image instruction indicates that the position of each picture category ID in said picture category ID list determines the position of a corresponding picture in said composite image.

87. The apparatus of claim 61 wherein said means for providing further comprises means for providing said picture category ID list for displaying serially a composite image including at least one picture based on said picture category ID list.

88. The apparatus of claim 87 wherein said means for providing further comprises means for providing said picture category ID list for displaying serially in groups of two a composite image including at least one picture based on said picture category ID list.

89. The apparatus of claim 87 wherein said means for providing further comprises means for providing said picture category ID list for displaying serially in groups of four a composite image including at least one picture based on said picture category ID list.

90. The apparatus of claim 85 wherein said at least one composite image instruction indicates at least one entry token to be superimposed on a picture corresponding to a picture category ID in said picture category ID list.

91. An apparatus for dynamic personal identification number management, comprising:
a memory for storing at least one PIN comprising at least one picture category ID;
a category selector for creating a picture category ID list in response to an access request, said picture category ID list including said at least one picture category ID, said category selector coupled to said memory;
a picture database for storing at least one categorized picture;
an image generator for generating a composite image comprising a picture for each of said at least one category ID, each picture obtained from said picture database; and
a PIN comparator for receiving an entry token list and an entry token correspondence list, said entry token correspondence list including at least one entry token that corresponds with said at least one picture category ID, said PIN comparator further configured to grant said access request based upon whether said entry token correspondence list matches said entry token list.

92. The apparatus of claim 91, further comprising a PIN selector to select a PIN comprising at least one picture category ID.

93. The apparatus of claim 91 wherein said category selector is further configured to use a randomized number generator to determine the position of said at least one picture category ID within said picture category ID list.

94. The apparatus of claim 91 wherein said category selector is further configured to use a randomized number generator to determine the position of picture categories other than said least one picture category ID within said picture category ID list.

95. The apparatus of claim 91 wherein said category selector is further configured to use a randomized number generator to select picture categories other than said at least one picture category ID within said picture category ID list.

96. The apparatus of claim 91 wherein the number of picture categories in said PIN is less than the number of picture categories in said picture category ID list.

97. The apparatus of claim 91 wherein said PIN comparator is further configured to grant said access request based on said entry token correspondence list and said entry token list.

98. The apparatus of claim 91 wherein said PIN comparator is further configured to grant said access request if each picture category in said PIN is represented by an entry token in said entry token list.

99. The apparatus of claim 91 wherein said entry token correspondence list indicates a required order for entry tokens in said entry token list.

100. The apparatus of claim 91 wherein
said category selector is further configured to associate each of said picture categories in said PIN with an entry token; and
said PIN comparator is further configured to grant said access request if each entry token in said entry token list matches the entry token associated with the corresponding picture category ID of the PIN.

101. The apparatus of claim 91 wherein said PIN comparator is further configured to grant said access request if at least one but less than all of said entry tokens in said entry token list correspond to a picture category in said PIN.

102. The apparatus of claim 91 wherein said apparatus is further configured to send at least one PIN instruction in response to said request.

103. The apparatus of claim 102 wherein said at least one PIN instruction comprises at least one picture category ID.

104. The apparatus of claim 102 wherein said at least one PIN instruction comprises a required picture category sequence.

105. The apparatus of claim 102 wherein said apparatus is further configured to repeat said at least one PIN instruction for successive access requests.

106. The apparatus of claim 91 wherein said apparatus is further configured to receive from a user at least one picture belonging to said at least one picture category ID.

107. The apparatus of claim 91 wherein said apparatus is further configured to receive from a user said at least one picture category.

108. The apparatus of claim 91 wherein said category selector is further configured to create said entry token correspondence list.

109. The apparatus of claim 91 wherein
said category selector is further configured to select at least one composite image instruction; and
said apparatus is further configured to provide said composite image instruction for use in generating said composite image.

110. The apparatus of claim 109 wherein said at least one composite image instruction indicates that the position of each picture category ID in said picture category ID list determines the position of a corresponding picture in said composite image.

111. The apparatus of claim 91 wherein said image generator is further configured to present each picture in said composite image serially.

112. The apparatus of claim 111 wherein said image generator is further configured to present each picture in said composite image serially in groups of two pictures.

113. The apparatus of claim 111 wherein said image generator is further configured to present each picture in said composite image serially in groups of four pictures.

114. The apparatus of claim 91 wherein said apparatus comprises a smart card.

115. The apparatus of claim 114 wherein said smart card comprises a Java Card™ technology-enabled smart card.

116. The apparatus of claim 114 wherein said smart card comprises a CDMA (Code Division Multiple Access) technology-enabled smart card.

117. The apparatus of claim 114 wherein said smart card comprises a SIM (Subscriber Identity Module) card.

118. The apparatus of claim 114 wherein said smart card comprises a WIM (Wireless Interface Module).

119. The apparatus of claim 114 wherein said smart card comprises a USIM (Universal Subscriber Identity Module).

120. The apparatus of claim 114 wherein said smart card comprises a UIM (User Identity Module).

121. The apparatus of claim 114 wherein said smart card comprises a R-UIM (Removable User Identity Module).

122. An apparatus for dynamic personal identification number management, comprising:
a memory for storing at least one PIN comprising at least one picture category ID;
a category selector for creating a picture category ID list in response to an access request, said picture category ID list including said at least one picture category ID, said category selector coupled to said memory; and
a PIN comparator for receiving an entry token list and an entry token correspondence list, said entry token correspondence list including at least one entry token that corresponds with said at least one picture category ID, said PIN comparator further configured to grant said access request based upon whether said entry token correspondence list matches said entry token list.

123. The apparatus of claim 122, further comprising a PIN selector to select a PIN comprising at least one picture category ID.

124. The apparatus of claim 122 wherein said category selector is further configured to use a randomized number generator to determine the position of said at least one picture category ID within said picture category ID list.

125. The apparatus of claim 122 wherein said category selector is further configured to use a randomized number generator to determine the position of picture categories other than said least one picture category ID within said picture category ID list.

126. The apparatus of claim 122 wherein said category selector is further configured to use a randomized number generator to select picture categories other than said at least one picture category ID within said picture category ID list.

127. The apparatus of claim 122 wherein the number of picture categories in said PIN is less than the number of picture categories in said picture category ID list.

128. The apparatus of claim 122 wherein said PIN comparator is further configured to grant said access request based on said entry token correspondence list and said entry token list.

129. The apparatus of claim 122 wherein said PIN comparator is further configured to grant said access request if each picture category in said PIN is represented by an entry token in said entry token list.

130. The apparatus of claim 122 wherein said entry token correspondence list indicates a required order for entry tokens in said entry token list.

131. The apparatus of claim 122 wherein
said category selector is further configured to associate each of said picture categories in said PIN with an entry token; and
said PIN comparator is further configured to grant said access request if each entry token in said entry token list matches the entry token associated with the corresponding picture category ID of the PIN.

132. The apparatus of claim 122 wherein said PIN comparator is further configured to grant said access request if at least one but less than all of said entry tokens in said entry token list correspond to a picture category in said PIN.

133. The apparatus of claim 122 wherein said apparatus is further configured to send at least one PIN instruction in response to said request.

134. The apparatus of claim 133 wherein said at least one PIN instruction comprises at least one picture category ID.

135. The apparatus of claim 133 wherein said at least one PIN instruction comprises a required picture category sequence.

136. The apparatus of claim 133 wherein said apparatus is further configured to repeat said at least one PIN instruction for successive access requests.

137. The apparatus of claim 122 wherein said apparatus is further configured to receive from a user at least one picture belonging to said at least one picture category ID.

138. The apparatus of claim 122 wherein said apparatus is further configured to receive from a user said at least one picture category.

139. The apparatus of claim 122 wherein said category selector is further configured to create said entry token correspondence list.

140. The apparatus of claim 122 wherein
said category selector is further configured to select at least one composite image instruction; and
said apparatus is further configured to provide said composite image instruction for use in generating said composite image.

141. The apparatus of claim 140 wherein said at least one composite image instruction indicates that the position of each picture category ID in said picture category ID list determines the position of a corresponding picture in said composite image.

142. The apparatus of claim 140 wherein said at least one composite image instruction indicates each picture in said composite image should be presented serially.

143. The apparatus of claim 140 wherein said at least one composite image instruction indicates pictures comprising said composite image should be presented serially in groups of two pictures.

144. The apparatus of claim 140 wherein said at least one composite image instruction indicates pictures comprising said composite image should be presented serially in groups of four pictures.

145. The apparatus of claim 122 wherein said apparatus comprises a smart card.

146. The apparatus of claim 122 wherein said smart card comprises a Java Card™ technology-enabled smart card.

147. The apparatus of claim 145 wherein said smart card comprises a CDMA (Code Division Multiple Access) technology-enabled smart card.

148. The apparatus of claim 145 wherein said smart card comprises a SIM (Subscriber Identity Module) card.

149. The apparatus of claim 145 wherein said smart card comprises a WIM (Wireless Interface Module).

150. The apparatus of claim 145 wherein said smart card comprises a USIM (Universal Subscriber Identity Module).

151. The apparatus of claim 145 wherein said smart card comprises a UIM (User Identity Module).

152. The apparatus of claim 145 wherein said smart card comprises a R-UIM (Removable User Identity Module).

153. A method for dynamic personal identification number (PIN) management, the method comprising:
receiving a picture category ID list;
selecting a picture for each of said picture categories in said picture category ID list;
positioning each said picture within a composite image;
presenting said composite image to a user;
receiving an entry token list in response to said presenting, at least one entry token in said entry token list corresponding to a picture within said composite image; and
sending said entry token list.

154. The method of claim 153 wherein said positioning further comprises positioning each said picture within said composite image based upon the position of the corresponding picture category ID in said picture category ID list.

155. The method of claim 153 wherein
said receiving further comprises receiving at least one composite image instruction; and
said positioning further comprises positioning each said picture within a composite image based upon said at least one composite image instruction.

156. The method of claim 155 wherein said presenting further comprises presenting each picture in said composite image serially.

157. The method of claim 156 wherein said presenting further comprises presenting each picture in said composite image serially in groups of two pictures.

158. The method of claim 156 wherein said presenting further comprises presenting each picture in said composite image serially in groups of four pictures.

159. The method of claim 155, further comprising superimposing an entry token on at least one picture in said composite image based on said at least one composite image instruction.

160. The method of claim 159 wherein said entry token comprises an alphanumeric character.

161. The method of claim 160 wherein said entry token comprises a number.

162. The method of claim 160 wherein said entry token comprises a letter.

163. The method of claim 159 wherein said entry token comprises a non-alphanumeric symbol.

164. The method of claim 153 wherein at least one of said pictures belongs to a plurality of picture categories.

165. The method of claim 153 wherein at least one of said pictures comprises two or more sub-pictures, at least one of said sub-pictures associated with said corresponding picture category.

166. The method of claim 153 wherein said selecting further comprises using a randomized process to select a picture for a picture category ID in said picture category ID list if more than one picture belongs to said picture category.

167. The method of claim 153 wherein said selecting is based upon the last time a picture was selected if more than one picture belongs to said picture category.

168. The method of claim 153 wherein said composite image comprises a rectangular grid of pictures.

169. The method of claim 168 wherein said composite image comprises a square grid of pictures.

170. The method of claim 153 wherein at least one of said picture categories in said picture category ID list is repeated in said picture category ID list.

171. A program storage device readable by a machine, embodying a program of instructions executable by the machine to perform a method for dynamic personal identification number management, the method comprising:
receiving a picture category ID list;
selecting a picture for each of said picture categories in said picture category ID list;
positioning each said picture within a composite image;
presenting said composite image to a user;
receiving an entry token list in response to said presenting, at least one entry token in said entry token list corresponding to a picture within said composite image; and
sending said entry token list.

172. The program storage device of claim 171 wherein said positioning further comprises positioning each said picture within said composite image based upon the position of the corresponding picture category ID in said picture category ID list.

173. The program storage device of claim 171 wherein
said receiving further comprises receiving at least one composite image instruction; and
said positioning further comprises positioning each said picture within a composite image based upon said at least one composite image instruction.

174. The program storage device of claim 173 wherein said presenting further comprises presenting each picture in said composite image serially.

175. The program storage device of claim 174 wherein said presenting further comprises presenting each picture in said composite image serially in groups of two pictures.

176. The program storage device of claim 174 wherein said presenting further comprises presenting each picture in said composite image serially in groups of four pictures.

177. The program storage device of claim 173 wherein said method further comprises superimposing an entry token on at least one picture in said composite image based on said at least one composite image instruction.

178. The program storage device of claim 171 wherein at least one of said pictures belongs to a plurality of picture categories.

179. The program storage device of claim 171 wherein at least one of said pictures comprises two or more sub-pictures, at least one of said sub-pictures associated with said corresponding picture category.

180. The program storage device of claim 171 wherein said selecting further comprises using a randomized process to select a picture for a picture category ID in said picture category ID list if more than one picture belongs to said picture category.

181. The program storage device of claim 171 wherein said selecting is based upon the last time a picture was selected if more than one picture belongs to said picture category.

182. The program storage device of claim 171 wherein said composite image comprises a rectangular grid of pictures.

183. The program storage device of claim 182 wherein said composite image comprises a square grid of pictures.

184. The program storage device of claim 171 wherein at least one of said picture categories in said picture category ID list is repeated in said picture category ID list.

185. An apparatus for dynamic personal identification number management, the apparatus comprising:
means for receiving a picture category ID list;
means for selecting a picture for each of said picture categories in said picture category ID list; and
means for positioning each said picture within a composite image.

186. The apparatus of claim 185, further comprising:
means for presenting said composite image to a user;
means for receiving an entry token list in response to said presenting, at least one entry token in said entry token list corresponding to a picture within said composite image; and
means for sending said entry token list.

187. The apparatus of claim 185 wherein said means for positioning further comprises means for positioning each said picture within said composite image based upon the position of the corresponding picture category ID in said picture category ID list.

188. The apparatus of claim 185 wherein
said means for receiving further comprises means for receiving at least one composite image instruction; and
said means for positioning further comprises means for positioning each said picture within a composite image based upon said at least one composite image instruction.

189. The apparatus of claim 188 wherein said presenting further comprises presenting each picture in said composite image serially.

190. The apparatus of claim 189 wherein presenting further comprises presenting each picture in said composite image serially in groups of two pictures.

191. The apparatus of claim 189 wherein presenting further comprises presenting each picture in said composite image serially in groups of four pictures.

192. The apparatus of claim 188, further comprising means for superimposing an entry token on at least one picture in said composite image based on said at least one composite image instruction.

193. The apparatus of claim 185 wherein at least one of said pictures belongs to a plurality of picture categories.

194. The apparatus of claim 185 wherein at least one of said pictures comprises two or more sub-pictures, at least one of said sub-pictures associated with said corresponding picture category.

195. The apparatus of claim 185 wherein said means for selecting further comprises means for using a randomized process to select a picture for a picture category ID in said picture category ID list if more than one picture belongs to said picture category.

196. The apparatus of claim 185 wherein said means for selecting is based upon the last time a picture was selected if more than one picture belongs to said picture category.

197. The apparatus of claim 185 wherein said composite image comprises a rectangular grid of pictures.

198. The apparatus of claim 197 wherein said composite image comprises a square grid of pictures.

199. The apparatus of claim 185 wherein at least one of said picture categories in said picture category ID list is repeated in said picture category ID list.

200. The apparatus of claim 185, further comprising means for creating an entry token correspondence list including at least one token that corresponds with at least one picture category in said picture category ID list.

201. An apparatus for dynamic personal identification number management, comprising:
a picture database for storing at least one categorized picture; and
an image generator configured to receive a picture category ID list, said image generator further configured to select a picture from said picture database for each of said picture categories in said picture category ID list, said image generator further configured to position each said picture within a composite image based upon said picture category ID list.

202. The apparatus of claim 201 wherein
said image generator is further configured to provide said composite image for display to a user;
said apparatus is further configured to receive an entry token list after providing said composite image, at least one entry token in said entry token list corresponding to a picture within said composite image and
said apparatus is further configured to provide said entry token list to determine whether said user is authorized to access a service.

203. The apparatus of claim 201 wherein said positioning further comprises positioning each said picture within said composite image based upon the position of the corresponding picture category ID in said picture category ID list.

204. The apparatus of claim 201 wherein
said image generator is further configured to receive at least one composite image instruction; and
said image generator is further configured to position each said picture within said composite image based upon said at least one composite image instruction.

205. The apparatus of claim 202 wherein said image generator is further configured to provide each picture in said composite image for display to said user serially.

206. The apparatus of claim 205 wherein said image generator is further configured to provide each picture in said composite image for display to said user serially in groups of two pictures.

207. The apparatus of claim 205 wherein said image generator is further configured to provide each picture in said composite image for display to said user serially in groups of four pictures.

208. The apparatus of claim 201 wherein said image generator is further configured to superimpose an entry token on at least one picture in said composite image.

209. The apparatus of claim 204 wherein said image generator is further configured to superimpose an entry token on at least one picture in said composite image based on said at least one composite image instruction.

210. The apparatus of claim 201 wherein at least one of said pictures belongs to a plurality of picture categories.

211. The apparatus of claim 201 wherein at least one of said pictures comprises two or more sub-pictures, at least one of said sub-pictures associated with said corresponding picture category.

212. The apparatus of claim 201 wherein said image generator is further configured to use a randomized number generator to select a picture for a picture category ID in said picture category ID list if more than one picture belongs to said picture category.

213. The apparatus of claim 201 wherein said image generator is further configured to select a picture based upon the last time a picture was selected if more than one picture belongs to said picture category.

214. The apparatus of claim 201 wherein said composite image comprises a rectangular grid of pictures.

215. The apparatus of claim 214 wherein said composite image comprises a square grid of pictures.

216. The apparatus of claim 201 wherein at least one of said picture categories in said picture category ID list is repeated in said picture category ID list.

217. The apparatus of claim 201 wherein said apparatus comprises a mobile phone.

218. The apparatus of claim 201 wherein said apparatus comprises a Web server.

219. The apparatus of claim 201 wherein said apparatus is further configured to create an entry token correspondence list including at least one token that corresponds with at least one picture category in said picture category ID list.

220. An apparatus for dynamic personal identification number management, comprising:
a picture database for storing at least one categorized picture; and
an image generator configured to receive a picture category ID list, said image generator further configured to select a picture from said picture database for each of said picture categories in said picture category ID list, said image generator further configured to position each said picture within a composite image based upon said picture category ID list, said image generator further configured to provide said composite image for display to a user to determine whether said user is authorized to access a service.

221. The apparatus of claim 220 wherein said apparatus comprises a mobile phone.

222. The apparatus of claim 220 wherein said apparatus comprises a Web server.
